(19) United States
(12) Patent Application Publication
(10) Pub. No.: US 2025/0077896 A1
(43) Pub. Date: Mar. 6, 2025

(54) METHODS AND SYSTEMS THAT DEFER EDGE-WEIGHT CALCULATION AND GRAPH COMPLETION PRIOR TO, AND DURING, OPTIMAL-GRAPH-TRAVERSAL DETERMINATION

(71) Applicant: VMware LLC, Palo Alto, CA (US)

(72) Inventors: Jens Schauder, Braunschweig (DE); Martin Lippert, Hamburg (DE)

(21) Appl. No.: 18/242,654

(22) Filed: Sep. 6, 2023

(51) Int. Cl. G06N 5/01

(52) U.S. Cl. CPC G06N 5/01

(57) ABSTRACT

The current application is directed to optimal, locally optimal, and/or near-optimal path determination that defers edge-weight computations, avoids redundant edge-weight computations, and that does not require initial complete graph construction. Many real-world problems are not efficiently solved by current graph-traversal-determination methods because of the overheads and computational complexities involved in edge-weight computations. Moreover, it may be difficult or impossible to construct complete graphs to which current graph-traversal-determination methods can be applied. The currently disclosed optimal, locally optimal, and/or near-optimal path-determination methods and systems construct incomplete graphs during optimal, locally optimal, and/or near-optimal path determination, deferring node generation and edge-weight computations until necessary to expand incomplete graphs during the search for optimal, locally optimal, and/or near-optimal graph-traversal paths.

### TECHNICAL FIELD

The current document is directed to methods and systems that determine optimal, locally optimal, and near-optimal traversal paths through graphs in order to identify optimal, locally optimal, and near-optimal sequences of steps or actions that represent solutions to a wide variety of different problem domains.

### BACKGROUND

A fundamental set of computational methods and systems are devoted to determining optimal graph traversals in order to identify optimal sequences of steps or actions that can be taken to solve various different types of problems in many different problem domains. There are a variety of different methods used to determine optimal graph traversals, including the Dijkstra shortest-path method. While widely applicable to a variety of different types of graphs and graph traversals, these methods may be impractical or impossible to use to address particular problem domains due to problem-domain-specific computational overheads and complexities. Designers, manufacturers, and vendors of computational methods and systems used to solve many different types of real-world problems therefore seek new and/or improved optimal-graph-traversal-determination methods and systems in order to identify optimal sequences of steps or actions that can be taken to solve the many different types of real-world problems that cannot be addressed using current optimal-graph-traversal-determination methods and systems.

### SUMMARY

The current application is directed to optimal, locally optimal, and/or near-optimal path determination that defers edge-weight computations, avoids redundant edge-weight computations, and that does not require initial complete graph construction. Many real-world problems are not efficiently solved by current graph-traversal-determination methods because of the overheads and computational complexities involved in edge-weight computations. Moreover, it may be difficult or impossible to construct complete graphs to which current graph-traversal-determination methods can be applied. The currently disclosed optimal, locally optimal, and or near-optimal path-determination methods and systems construct incomplete graphs during optimal, locally optimal, and/or near-optimal path determination, deferring node generation and edge-weight computations until necessary to expand incomplete graphs during the search for optimal, locally optimal, and/or near-optimal graph-traversal paths.

### BRIEF DESCRIPTION OF THE DRAWINGS

FIG. 1 provides a general architectural diagram for various types of computers.

FIG. 2 illustrates an Internet-connected distributed computing system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate two types of virtual machine and virtual-machine execution environments.

FIG. 6 illustrates a graph.

FIG. 7 illustrates four different simple data structures used in a well-known optimal-path-determination method discussed below with reference to FIGS. 8A-C.

FIGS. 8A-C provide control-flow diagrams that illustrate a routine “SP,” which represents one version of the well-known Dijkstra shortest-path method.

FIG. 9 illustrates operation of the routine “SP,” discussed above with reference to FIGS. 8A-C, on the simple example graph shown in FIG. 6.

FIGS. 10A-B illustrate use of a priority queue QP in place of the list Q for a more computationally efficient implementation of the optimal-path-determination represented by routine “SP.”

FIG. 11 illustrates a first node-number problem associated with the optimal-path-determination methods discussed above with reference to FIGS. 7-10B.

FIG. 12 illustrates a second weight-determination problem associated with the optimal-path-determination methods discussed above with reference to FIGS. 7-10B.

FIGS. 13A-B illustrate logical components of one implementation of the currently disclosed methods and systems.

FIGS. 14A-C provide control-flow diagrams for a number of above-mentioned local-cost-instance and Cstack member functions.

FIG. 15 illustrates a final logical component used in the currently disclosed methods and systems.

FIGS. 16A-D) provide control-flow diagrams for the functions addEdge and compareStoS.

FIGS. 17A-C provide control-flow diagrams for a routine “SP*” that represents one implementation of the currently disclosed methods and systems.

FIGS. 18A-D illustrate the general concept of scope and the problem of identifying an optimal, near optimal, or locally optimal sequence of code changes needed to provide access to an instance of a type within a current program scope in which the type is not available.

FIGS. 19A-D) illustrates an integrated development environment (“IDE”) interface in which the currently disclosed optimization methods and systems can be employed to determine optimal, near optimal, or locally optimal sequences of code changes.

### DETAILED DESCRIPTION

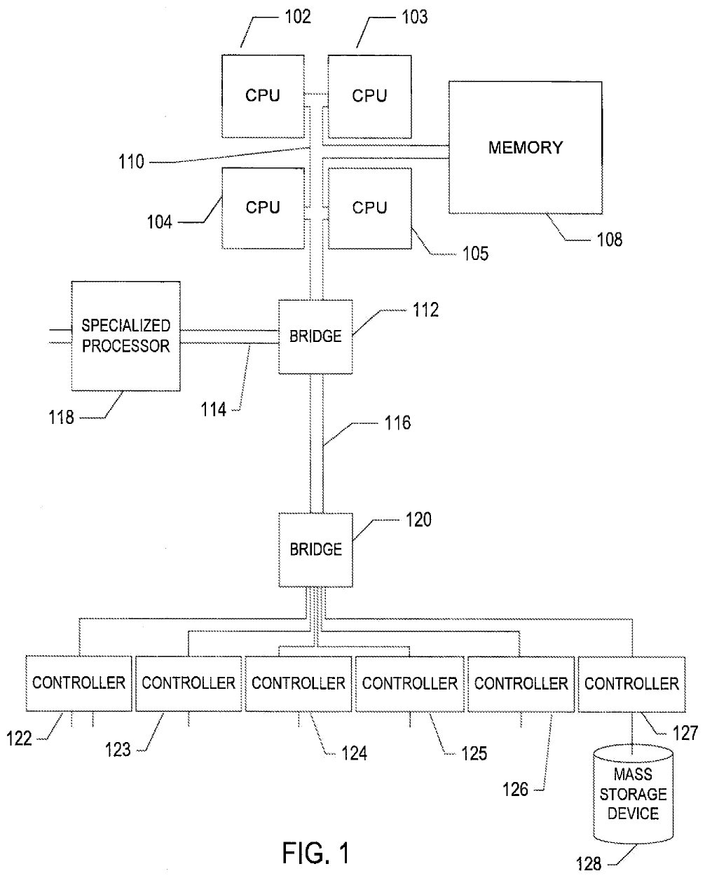

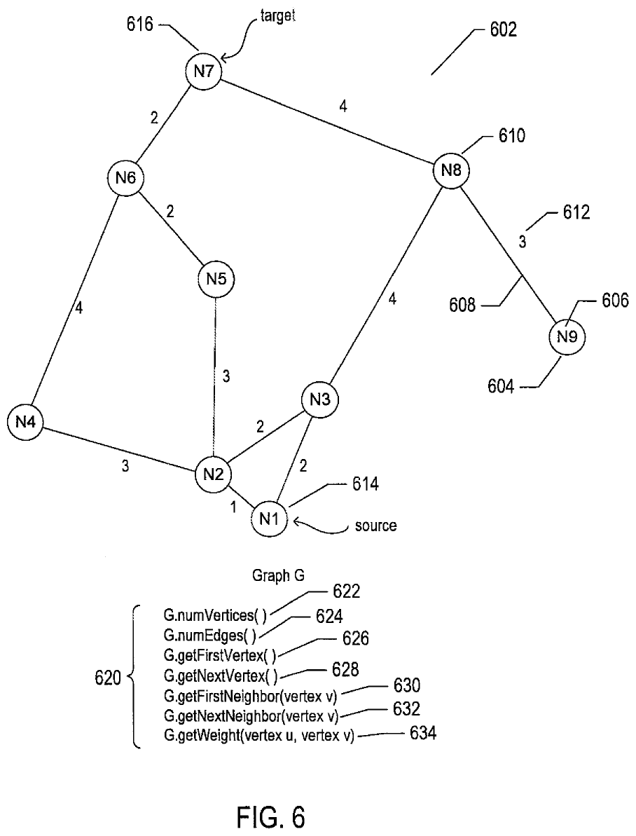

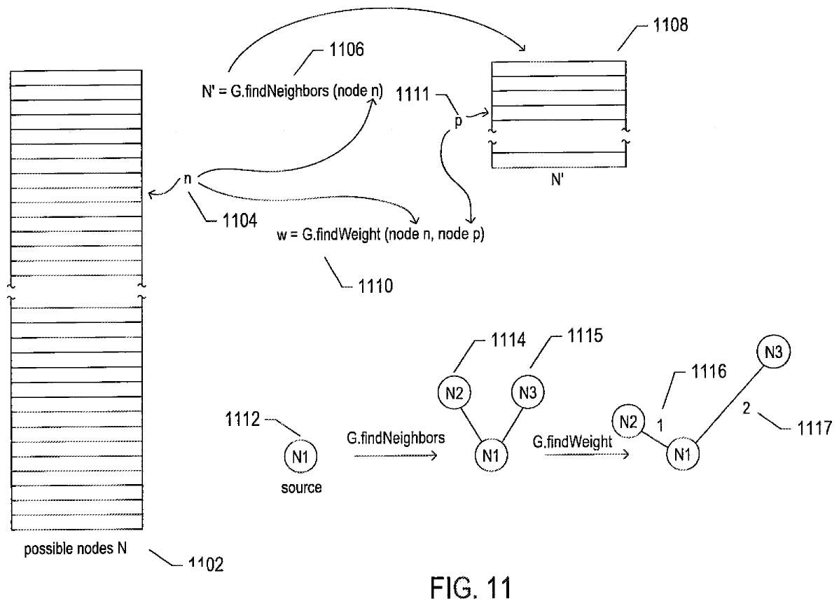

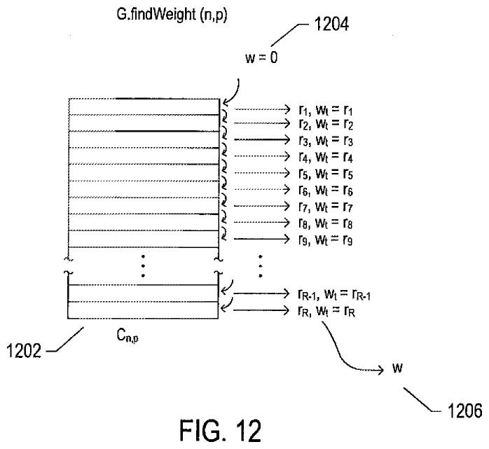

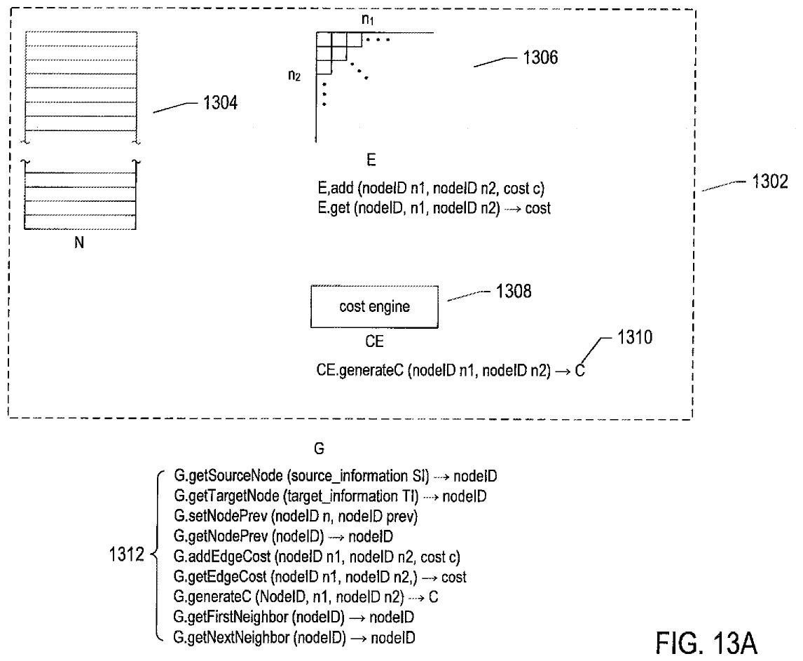

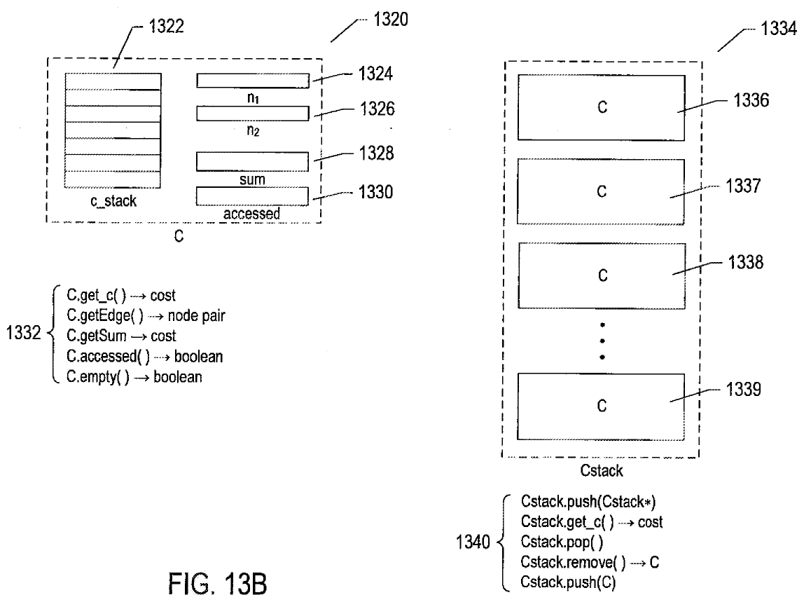

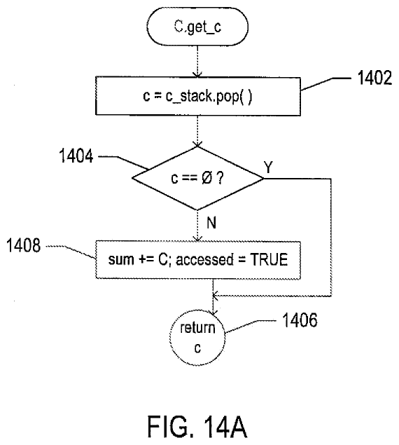

The current application is directed to optimal, locally optimal, and/or near-optimal path determination that defers edge-weight computations, avoids redundant edge-weight computations, and that does not require initial complete graph construction. In a first subsection, below, a description of computer hardware and computational systems is provided, with reference to FIGS. 1-5D. In a second subsection, an overview of optimal-path determination is provided with reference to FIGS. 6-10B. A third subsection provides an overview of the problem domain to which the currently disclosed systems and methods are directed, with reference to FIGS. 11-12. Finally, in a fourth subsection, the currently disclosed methods and systems are discussed with reference to FIGS. 13A-19D.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

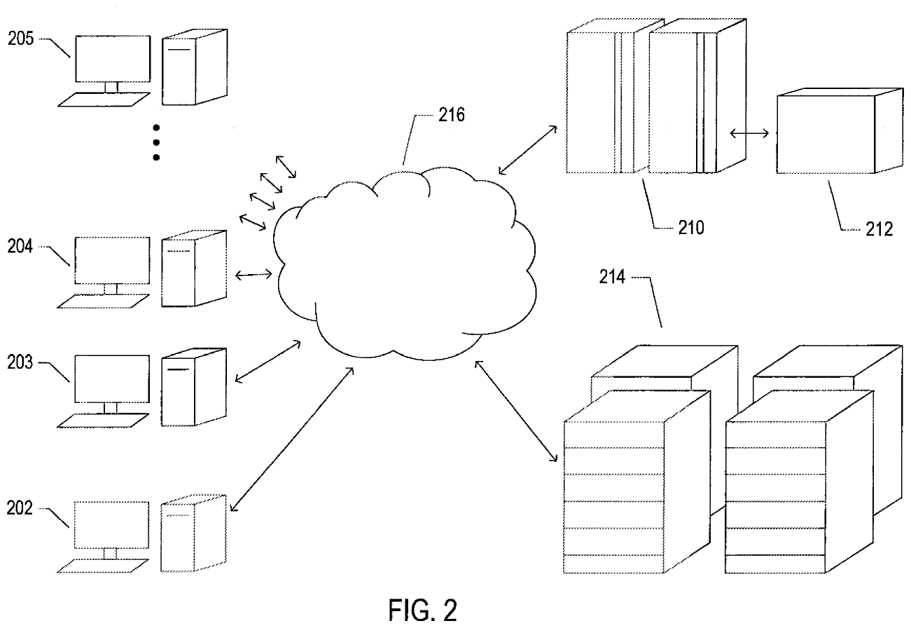

FIG. 2 illustrates an Internet-connected distributed computing system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

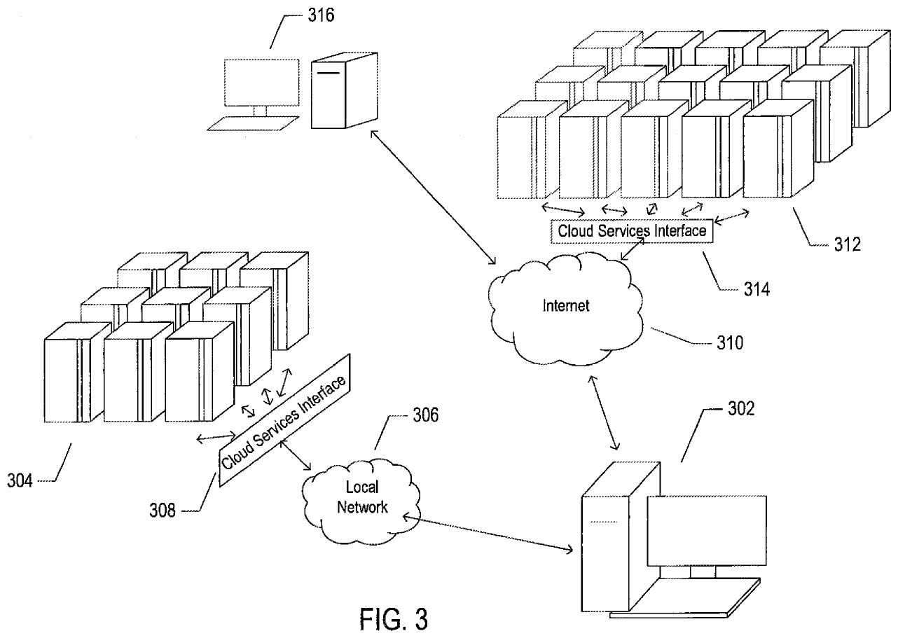

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

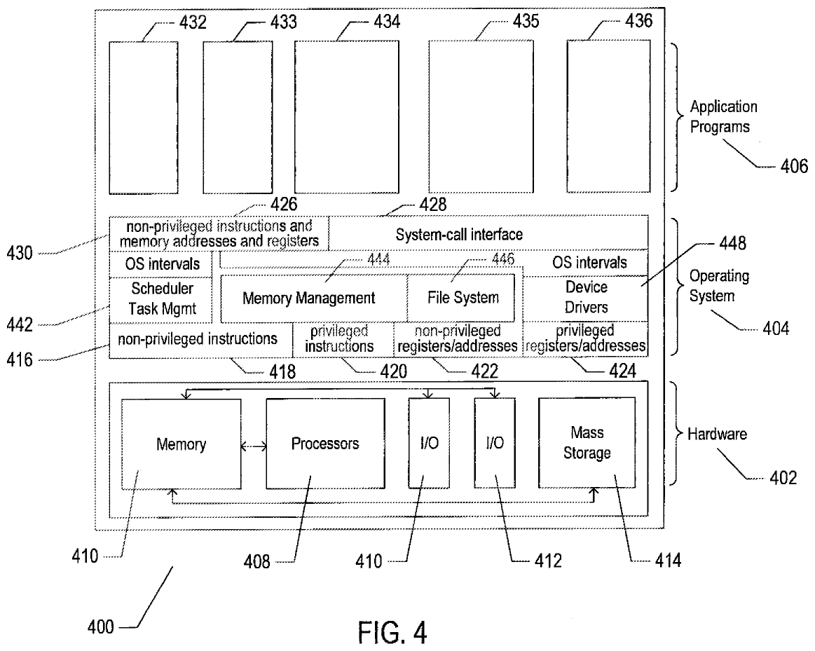

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O) devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computing system for high-availability, fault-tolerance, and load-balancing purposes. The problems are even greater in heterogeneous distributed computing systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

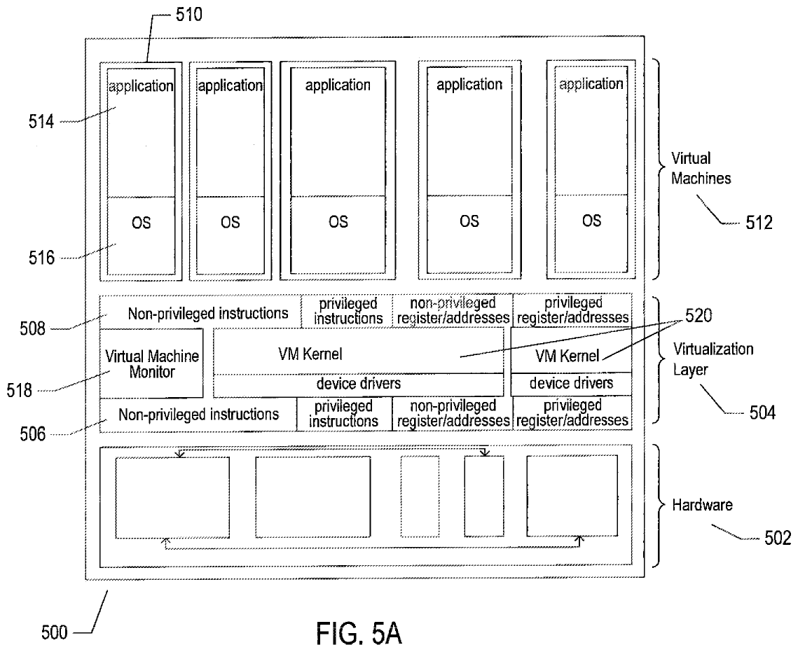

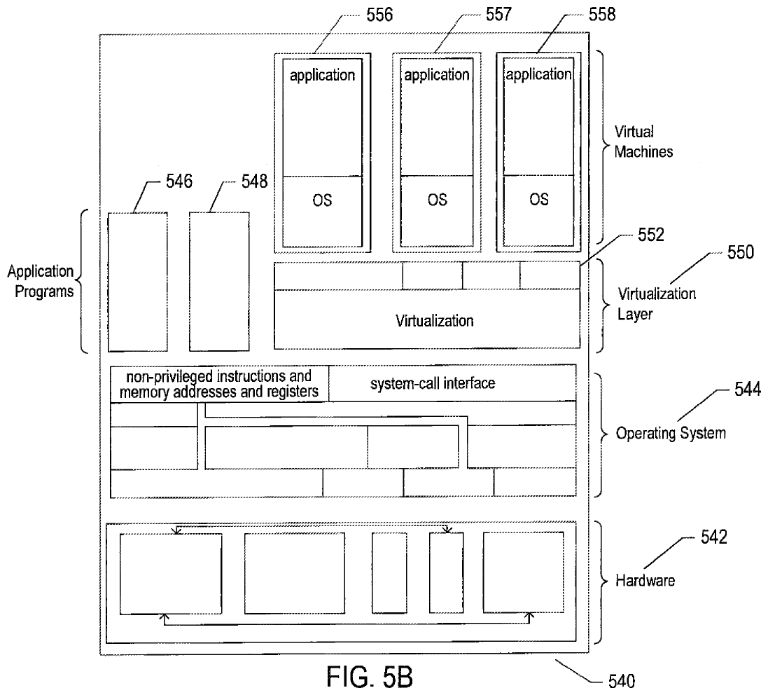

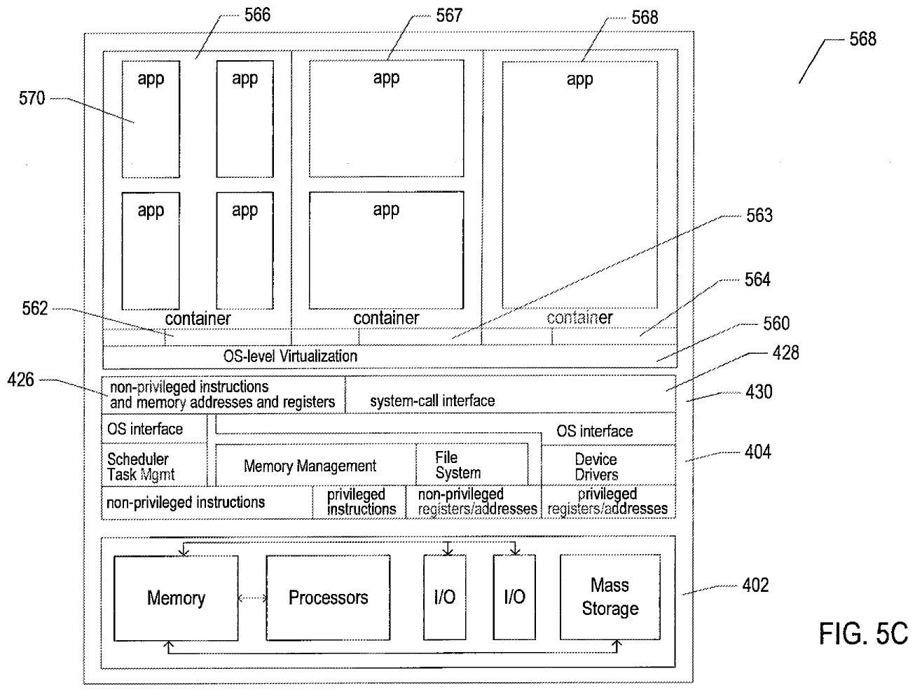

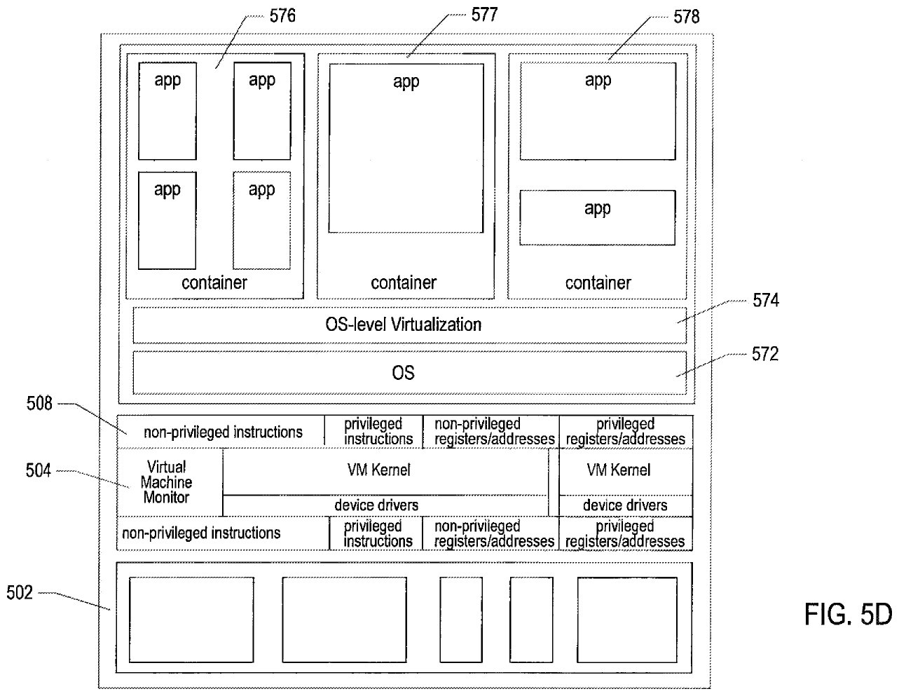

For all of these reasons, a higher level of abstraction, referred to as the “virtual machine,” has been developed and evolved to further abstract computer hardware in order to address many difficulties and challenges associated with traditional computing systems, including the compatibility issues discussed above. Figures SA-D illustrate several types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in Figure SA features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system.” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous, distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems. OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence. OSL virtualization uses operating-system features, such as namespace support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in Figure SA, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including-live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

### Overview of Optimal-Path Determination

FIG. 6 illustrates a graph. The graph G 602 comprises a set of nodes, each node of which, such as node 604, is represented by a disk containing an alphanumeric label, such as the alphanumeric label “N9” 606 contained in node 604. The nodes are connected by edges, represented by straight lines, such as the edge 608 connecting node 610 to node 604. The edges are labeled with weights, such as the weight “3” 612 associated with edge 608. An optimal traversal of the graph begins at a source node, such as node 614 in the example shown in FIG. 6, and ends at a target node, such as node 616 in the current example. The optimal graph traversal, or path, is a path through a sequence of edge-connected nodes leading from the source node to the target. In the simple example of FIG. 6, an optimal path is considered to be a path for which the sum of weights along the edges of the path is less than or equal to the sum of weights along all other possible paths from the source node to the target node. In the example of FIG. 6, the optimal path includes the sequence of nodes N1, N2, N5, N6, and N7 and has a total, or cumulative, weight of 8, which is smaller than the weights of any other possible path between nodes N1 and N7. This sequence of nodes represents a minimum-weight traversal. In other types of problem domains, a maximum-weight traversal represents the optimal path. The edge weights may correspond to distances or other physically meaningful values and node labels may correspond to identifiers for objects, components, computational entities, and many other types of entities, depending on the problem domain. In the following discussion, G may correspond to a graph class or graph type in a program or routine and may also correspond to an instance of the graph class G in a program or routine, depending on the context. The graph G class may include a number of member functions 620, including a member function which returns a number of vertices in a graph instance 622, a member function which return the number of edges in a graph instance 624, a member function which returns a first node or vertex in a graph instance 626, a member function which returns successive additional nodes or vertices in a graph instance 628, a member function which returns the first node or vertex neighbor of a specified node or vertex in a graph instance 630, a member function which returns successive additional node or vertex neighbors of a specified node or vertex in a graph instance 632, and a member function which returns the weight associated with an edge connecting two specified vertices or nodes in a graph instance 634. These are examples of many different possible member functions associated with a graph class that might be encountered in a computer program that constructs graphs and carries out optimal or near-optimal path determinations for constructed graphs.

In general, an optimal, near optimal, or locally optimal traversal path begins with a source node, ends with a target node, and includes 0, 1, or more additional nodes as well an edge that connects the source node to the target node or edges that interconnect the source node through the one or more additional nodes to the target node, and the cumulative weight of the optimal traversal path, which is the sum of the weights of the edges in the optimal traversal path, meets an optimization condition. For a graph that represents a minimization problem, the optimization condition requires that the cumulative weight of an optimal traversal path is less than or equal to the cumulative weights of all other traversal paths in the graph, that the difference between the cumulative weight of a near-optimal path and the cumulative weight of an optimal path of the graph is less than or equal to a threshold fraction of the cumulative weight of the optimal path, and that the cumulative weight of a locally optimal traversal path is less than or equal to the cumulative weights of all other traversal paths discovered in the graph during locally optimal traversal-path determination. For a graph that represents a maximization problem, the optimization condition requires that the cumulative weight of an optimal traversal path is greater than or equal to the cumulative weights of all other traversal paths in the graph, that the difference between the cumulative weight of an optimal path of the graph and the cumulative weight of a near-optimal path is less than or equal to a threshold fraction of the cumulative weight of the optimal path, and that the cumulative weight of a locally optimal traversal path is greater than or equal to the cumulative weights of all other traversal paths discovered in the graph.

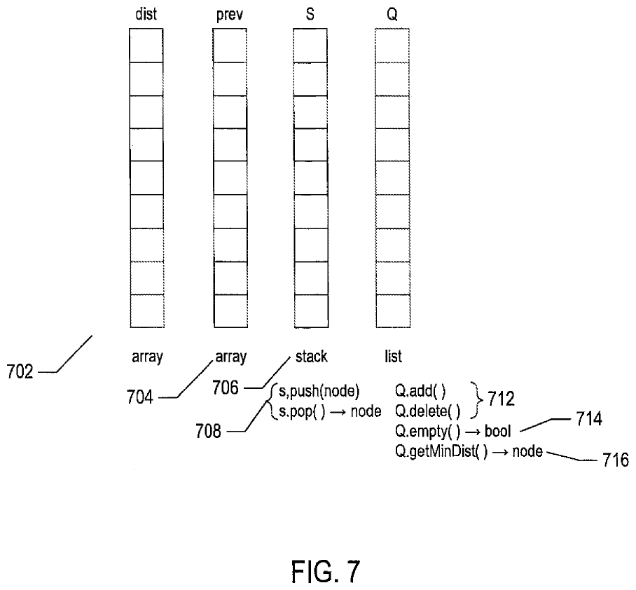

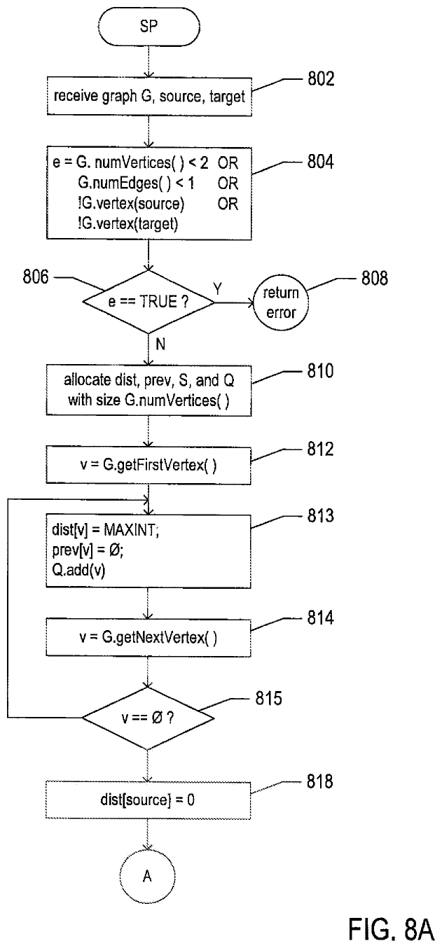

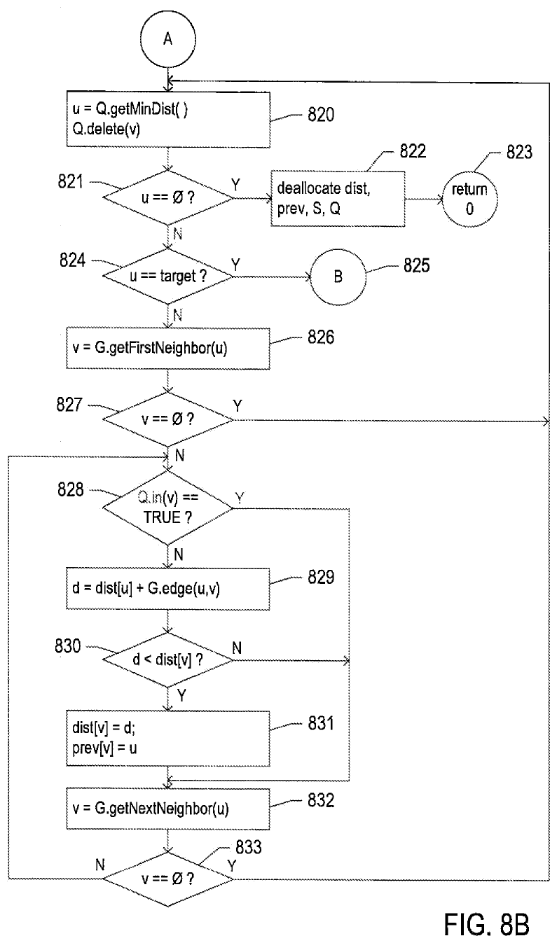

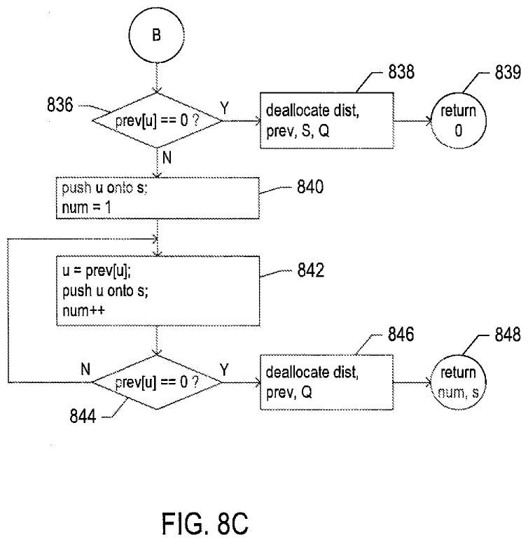

FIG. 7 illustrates four different simple data structures used in a well-known optimal-path-determination method discussed below with reference to FIGS. 8A-C. In this implementation, graph nodes are labeled with integer values and edge weights also have integer values. However, in alternative methods, different types of labels and weights may be used. Each element of the array dist 702 contains the cumulative weight or distance of a path beginning at the source node and ending at the node labeled with the integer index of the element. Initially, as discussed below, the array dist contains very large initialization values when a minimum-cumulative-weight optimal path is sought. When a lower-cumulative-weight path from the source node to a particular node is discovered during a search for an optimal graph traversal, the element of the array dist corresponding to the particular node is set to the lower cumulative weight. The array prev 704 is indexed by integers corresponding to node labels, like the array dist. The element indexed by a particular node label in the array prev contains the label of the node that precedes the particular node in the lowest-cumulative-weight path so far discovered from the source node to the particular node. The stack S 706 is used to construct the sequence of node labels for the determined optimal path from the source node to the target node. The stack S is associated with well-known stack operations push and pop 708. The list Q 710 stores the node labels for unvisited nodes during the optimal-path discovery process, as further discussed below. The list Q is associated with add and delete operations 712, a member function empty, which returns a Boolean value indicating whether or not the list includes at least one node label 714, and a member function getMinDist 716 which returns the unvisited node stored in the list Q associated with the lowest-cumulative-weight path from the source node to the unvisited node.

In general, member functions which return nodes or other values return the value Ø when there are no nodes or other values that can be returned. Depending on the data type returned by the member function, the symbol O may represent a particular value of the data type that cannot be validly returned by the member function, such as a negative integer for a node label.

FIGS. 8A-C provide control-flow diagrams that illustrate a routine “SP,” which represents one version of the well-known Dijkstra shortest-path method. In step 802, the routine “SP” receives a graph G, a source-node label or identifier source, and a target-node label or identifier target. In the control-flow diagrams, instances of large classes, such as a graph-class instance, are assumed to be passed by reference rather than by value. In general, these details are not explicitly shown in the control-flow diagrams. It can be assumed that arguments are passed by reference, when passing by reference is more efficient or when the argument is modified by the receiving routine, and are otherwise passed by value. In step 804, the routine “SP” sets the Boolean local variable e to the Boolean value of an expression used to detect errors in the received argument values. When the local variable e has the value TRUE, as determined in step 806, the routine “SP” returns an error value, in step 808. In general, routines such as the routine “SP” may detect a variety of different types of errors during execution. For the sake of clarity and brevity, these error-detection and error-reporting operations are generally omitted from the control-flow diagrams. In step 810, the routine “SP” allocates the above-discussed data structures dist, prev, S, and Q with sizes commensurate with the number of nodes or vertices in the graph G. In the loop of steps 812-815, the routine “SP” considers each node in graph G. The element corresponding to the currently considered node in the array dist is set to a very large value, the element corresponding to the currently considered node in the array prev is set to the Ø value, and the currently considered node is added to the list Q, in step 813. Finally, in step 818, the element of the array dist corresponding to the source node is set to the smallest possible distance 0.

Turning to FIG. 8B, the routine “SP” iteratively removes and considers each unvisited node from the list Q in the loop of steps 820-833. In step 820, the routine “SP” sets local variable u to the unvisited node in list Q with the least-cumulative-weight path from the source node so far observed by calling the member function getMinDist and then deletes node u from the list Q. Note that edge weights have non-negative values. When the local variable u contains the value Ø, as determined in step 821, the routine “SP” deallocates the allocated data structures, in step 822, and returns the value 0, in step 823. This return value 0 indicates that no path from the source node to the target node was successfully found by the routine “SP.” Otherwise, when local variable u contains the label of the target node, as determined in step 824, control flows to the first step in FIG. 8C, discussed below. When local variable u contains the target node, the routine “SP” has discovered a minimum-cumulative-weight path, or optimal path, from the source node to the target node in graph G. Note that there may be more than one optimal path. Otherwise, in the inner loop of steps 826-832, each neighbor node of the node u is considered. In step 826, the routine “SP” calls the member function get FirstNeighbor of the graph G to set local variable y to a first neighbor node of node u. When local variable v contains the value Ø, as determined in step 827, there are no further neighbors of node u to consider and control flows back to step 820 for a next iteration of the loop of steps 820-833. Otherwise, when node v is not currently contained in the list Q, as determined in step 828, node v has already been visited and therefore is not again considered. Therefore control flows to step 832, bypassing steps 829-831 which consider unvisited notes. When node v currently resides in list Q, as determined in step 828, local variable d is set to the sum of the current distance stored for node u in the array dist and the weight of the edge that connects node u to node v, in step 829. When the value stored in local variable d is less than the distance currently stored for node y in the array dist, as determined in step 830, the element in the array dist corresponding to node y is set to the contents of local variable d and the element in the array prev corresponding to node v is set to u, in step 831. In step 832, local variable v is set to the next neighbor of node u via the member function getNextNeighbor of graph G. When local variable v contains the value Ø, as determined in step 833, control flows back to step 820 for another iteration of the loop of steps 820-833. Otherwise, control flows back to step 828 for another iteration of the loop of steps 826-832. A node is thus visited, in steps 829-831, only once by the routine “SP.” Once a node is visited, it is removed from the list Q and is not again considered in steps 829-831.

Turning to FIG. 8C, the routine “SP” generates an optimal path using the stack S. In step 836, the routine “SP” determines whether the element for the target node u in the array prev has the value Ø. If so, and there is no path from the source node to the target node. Therefore, in step 838, the allocated data structures are deallocated and, in step 839, the routine “SP” returns the value 0. In this case, the source and target nodes are identical. In alternative implementations, the routine “SP” could return an optimal path consisting of only a single node rather than returning the value 0. When the element for the target node u in the array prev does not have the value Ø, as determined in step 836, the routine “SP, in step 840, pushes node u onto stack S and sets the value of local variable num to 1. In step 842, the routine “SP” sets local variable u to the value stored in the element associated with node u in the array prev, pushes node u onto stack S. and increments local variable num. When the value stored in the element associated with node u in the array prev is Ø, as determined in step 844, the entire optimal path has been stored in stack S. Therefore, the routine “SP” deallocates all of the allocated data structures other than the stack S, in step 846, and returns, in step 848, the value stored in local variable num, indicating the number of nodes in the optimal path, and stack S, which contains the optimal path. Otherwise, control flows back to step 842, where the next node of the optimal path is pushed onto stack S.

The above-discussed routine “SP” generates a sequence of graph nodes as an optimal traversal path. This sequence of nodes, and the set of edges connecting them to form the optimal path, represent a solution to a problem represented by the graph. It is assumed that the connecting edges and associated weights are available to the calling entity to reconstruct the traversal path and transform the traversal path into a sequence of objects, actions, and/or or steps that can be executed to solve the problem. Thus, an optimal-graph-traversal method or system is a component of a higher-level method or system that solves an optimization problem by representing the possible problem solutions as a graph and using the optimal-graph-traversal method or system to choose an optimal problem solution for execution.

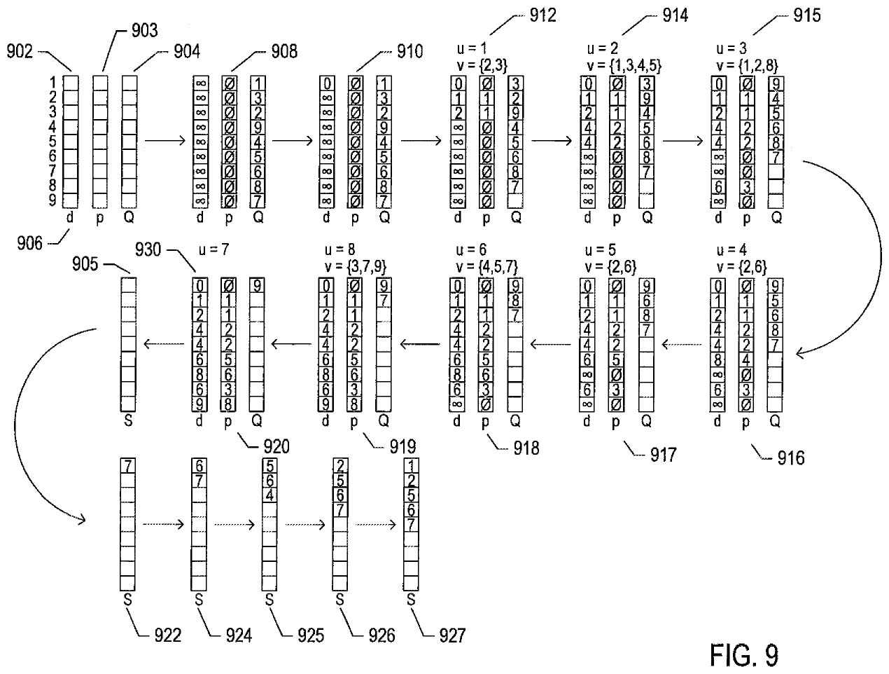

FIG. 9 illustrates operation of the routine “SP.” discussed above with reference to FIGS. 8A-C, on the simple example graph shown in FIG. 6. Operation of the routine “SP” is illustrated initially by showing the values in the dist 902 and prev 903 arrays and in the list Q 904 as they are initialized and then following each execution of step 820 in FIG. 8B. Then, storing of the optimal path in stack S 905 is illustrated. Initially, the arrays and list are uninitialized 906. Following completion of the loop of steps 812-815, the arrays and list are initialized 908. All of the distances stored in the array dist have large initial values, represented by the infinity symbol, and all of the node labels in the array prev are set to the value Ø. The list Q contains all of the nodes in graph G shown in FIG. 6. The contents of the arrays and list 910 are shown following execution of step 818 in FIG. 8A. After the first execution of step 820 in FIG. 8B, the contents of the arrays and list are shown in representations 912. After successive executions 914-920 of step 820, the target node is finally visited and removed from list Q. At that point, the stack S is empty 905. After execution of step 840 in FIG. 8C, the target node has been pushed onto stack S 922. Successive executions of step 842 (924-927 in FIG. 9) result in the optimal path stored in stack S.

The Dijkstra shortest-path method is but one example of many different shortest-path methods. While the Dijkstra shortest-path method is used as an example of graph-traversal optimization methods, the currently disclosed methods and systems may be based on many other graph-traversal optimization methods, in addition to the Dijkstra shortest-path method.

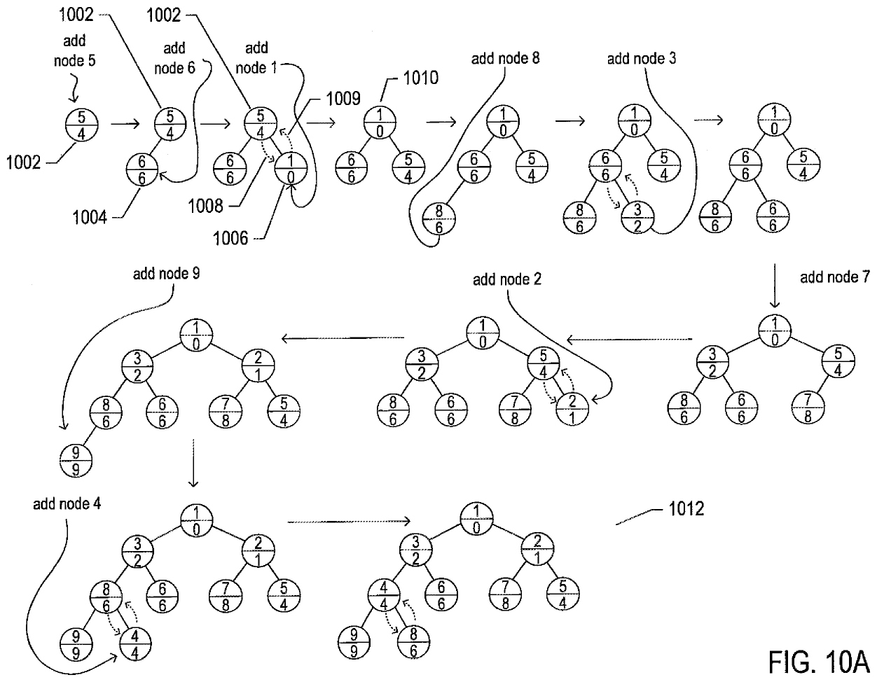

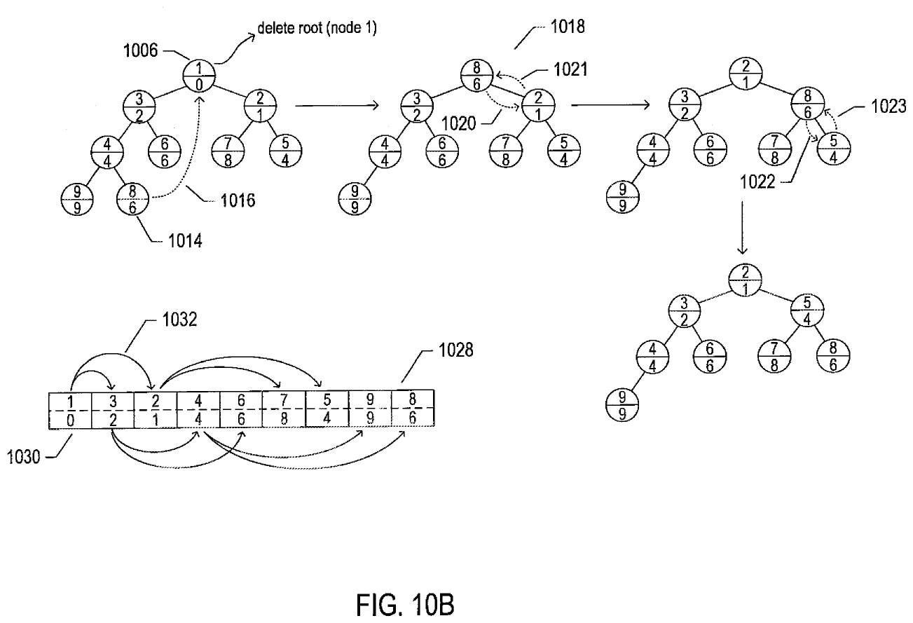

FIGS. 10A-B illustrate use of a priority queue OP in place of the list Q for a more computationally efficient implementation of the optimal-path-determination represented by routine “SP.” The priority queue is essentially a heap data structure that contains the node at the end of the currently observed lowest-cumulative-weight path from the source node as the root node of the heap data structure. FIG. 10A illustrates successive additions of nodes with corresponding weights shown in the array dist 930 in FIG. 9. The nodes are randomly selected for addition. Node 5 is first added (1002 in FIG. 10A) with distance, or cumulative weight, 4. The priority-queue nodes include both a graph-node label as well as the distance currently associated with the graph node. Nodes are always added to the next open position in the heap. Thus, the heap node for graph node 6 1004 is next added as the first child of the root node 1002. Since the distance associated with heap node 1004 is greater than the distance associated with the root node 1002, this addition preserves the heap properties of the heap, namely that the heap data structure is maximally compact and the root node is the heap node with the lowest associated weight or distance. Next, a heap node 1006 for graph node I is added to the heap. This addition violates the heap properties since the distance associated with heap node 1006 is smaller than that associated with the root heap node 1002. Therefore, as indicated by dashed arrows 1008-1009, the newly added heap node 1006 is exchanged with the root node to produce the resulting heap data structure 1010 with proper heap properties. Similar illustration conventions are used to illustrate construction of a final heap data structure 1012 containing all of the graph nodes and their associated distances shown in the array dist 930 in FIG. 9.

FIG. 10B illustrates removal of the root node from the heap data structure. When the root node 1006 is removed from the heap data structure, it is replaced by the last-added node 1014, as indicated by dashed arrow 1016. However, in this example, root-node removal and replacement results in a heap data structure that violates the heap properties 1018. Successive exchanges of nodes indicated by dashed arrows 1020-1021 and 1022-1023 produce a heap data structure 1026 that satisfies the heap properties. A priority queue can be represented by an array of elements 1028. Each element in the array includes a graph-node label and a distance. The root node is represented by the first element 1030 in the array. Curved arrows, such as curved arrow 1032, logically represent the edges, which are represented in an array implementation by the positions of the nodes in the array. Thus, array 1028 is equivalent to heap data structure 1012 in FIG. 10A.

Overview of the Problem Domain to which the Currently Disclosed Methods and Systems are Directed

FIG. 11 illustrates a first node-number problem associated with the optimal-path-determination methods discussed above with reference to FIGS. 7-10B. In many practical problem domains, the number of possible nodes in a graph representation of the problem domain may be quite large. The initialization step in the routine “SP” places values for all of the graph nodes into the arrays dist and prev and list Q prior to undertaking optimal-path determination. However, many problem domains may include so many possible graph nodes that it would be computationally infeasible or impossible to store node identifiers or node labels for all of the possible nodes in a priority queue or list. In fact, in certain problem domains, the number of possible graph nodes may well exceed the storage capacities of even large, distributed computer systems. However, it may still be possible to find an optimal or near-optimal graph traversal without construction of a complete graph containing all possible nodes. In order to address this problem, it is necessary to construct portions of a graph-based representation of a problem domain and to expand this construction during the process of determining an optimal or near-optimal path from a source node to a target node. As shown in FIG. 11, in these problem domains, there is a huge number of possible nodes 1102, far more than can be computationally enumerated and stored. Therefore, instead of carrying out the initialization carried out by the above-discussed routine “SP,” the graph includes member functions that allow the neighbors of a particular node to be computed on-the-fly. Thus, given a particular node identifier n 1104, which corresponds to one of the innumerable possible nodes 1102, the graph member function findNeighbors 1106 is called to compute a set of neighbor nodes 1108 for the particular node identifier n, and another graph member function findWeight 1110 can then be used to determine the weight of the edge that connects the particular node n 1104 with one of the neighboring nodes p selected from the computed set of neighbor nodes 1108. The process of determining an optimal path may constitute starting with a known source node 1112, then using the member function findNeighbors to compute the neighboring nodes of the source node 1114-1115, and then using the member function findWeight to compute the weights associated with the edges connecting the known source node to the neighboring nodes 1116-1117. This process can then be iteratively or recursively repeated for each of the neighbor nodes, then for each of the neighbors of the neighbor nodes, and so on in order to expand the graph outward from the source node during the process of determining an optimal path. In fact, the set of neighboring nodes 1108 may also be innumerable, in certain problem domains, but an incomplete graph can be constructed and expanded despite this fact, often resulting in finding at least a locally optimal path with respect to the incomplete graph.

FIG. 12 illustrates a second weight-determination problem associated with the optimal-path-determination methods discussed above with reference to FIGS. 7-10B. In the discussion of the routine “SP” and the discussion of FIG. 11, it is assumed that the determination of the weight associated with an edge is straightforward, similar to looking up the weight in a tabular representation of a graph. However, in many problem domains, the weight computation may itself be a computationally complex problem with onerous computational overheads. In FIG. 12, a set C_{n,p} of considerations or elementary computations 1202 is shown for computing the weight of the edge connecting nodes n and p. The full or complete weight associated with the edge is computed, as indicated in FIG. 12, by starting with a weight of 0.1204 and then successively carrying out the elementary computations or evaluating the considerations to produce results that are successively added to the weight. The final weight 1206 is produced as the result of adding the final result from the final elementary calculation or consideration to the variable containing the incremental weight values. However, when the number of considerations or elementary computations is large, the overhead for computing edge weights during determination of an optimal or near-optimal path from a source node to a target node may be far too large for practical implementation. This second weight-determination problem is far more serious than the first node-number problem discussed above with reference to FIG. 11. Currently, optimal-path-determination methods are easily overwhelmed and inapplicable when iterative or recursive edge-weight computations involve a large number of considerations or elementary computations.

### Currently Disclosed Methods and Systems

The currently disclosed methods and systems provide and employ an optimal-path-determination method that addresses the problems discussed above with reference to FIGS. 11-12. FIGS. 13A-B illustrate logical components of one implementation of the currently disclosed methods and systems. FIG. 13A shows components of an instance of a graph class G. In the following discussion. G may refer either to a class in a program or to an instance of the class. The graph G 1302 includes a set of already-generated nodes N 1304, an array or list of already fully computed edge weights E 1306, and a cost engine CE 1308 that generates a local cost instance C that represents the considerations or elementary computations that are used to compute the cumulative cost, or weight, of an edge that connects two specified nodes. The local cost instance C is discussed further, below. The set of already-generated nodes N and the set of already-generated edge weights E store nodes and edge weights that are generated on-the-fly, during determination of an optimal, locally optimal, or near-optimal path from a source node to a target node. The graph G is associated with a number of different member functions 1312. These include: (1) getSourceNode, which receives information about the source node, generates the source node, stores the source node in the set of already-generated nodes N, and returns an identifier for the source node: (2) getTargetNode, which receives information about the target node, generates the target node, stores the target node in the set of already-generated nodes N, and returns an identifier for the target node; (3) addEdgeCost, which receives two node identifiers and a computed edge weight or cost and adds the computed edge weight to the matrix or list E; (4) getEdgeCost, which receives two node identifiers and returns the cost or weight of the edge that connects them; (5) generateC, which receives two node identifiers and returns a local cost instance, for the edge that connects the two node identifiers, that is used to iteratively or recursively compute the weight of the edge; (6) getFirstNeighbor, which receives a node identifier and returns the identifier of a first neighbor node, generating and storing the first neighbor node when the first neighbor node has not previously been generated; (7) getNextNeighbor, which receives a node identifier and returns a node identifier for a next neighbor of the node, generating and storing the next neighbor node when the next neighbor node has not previously been generated; (8) setNodePrev, which associates a previous-node identifier with a specified node; and (9) getNodePrev, which retrieves the previous-node identifier associated with a specified node, or returns the value Ø when no previous-node identifier has been associated with the node. The graph G and the graph components shown in FIG. 13A are logical components. They may be included as actual components in an implementation but may also represent on-the-fly computations carried out during determination of an optimal, locally optimal, or near-optimal path within a graph represented by G. As discussed above, the representation of the graph may be incomplete due to the large or innumerable number of nodes and due to the computational overheads associated with determining final weights to associate with edges. For the sake of clarity, the logical components provide for a clear presentation of the currently disclosed methods and systems.

FIG. 13B illustrates two additional logical components of the currently disclosed methods and systems. As with the graph component, discussed above with reference to FIG. 13A, the two additional logical components may be actually implemented, in certain implementations of the currently disclosed methods and systems, but may instead logically represent computations or functionality included within implementations of the currently disclosed methods and systems. A local cost instance C 1320 represents the considerations or elementary computations that are used to generate an incomplete or complete edge weight. The local cost instance includes a c_stack 1322, which stores the set of considerations or elementary computations, node identifiers n1 1324 and n2 1326 that define the edge associated with the local cost instance, a variable sum 1328, which stores the currently computed incomplete or complete edge weight for the edge, and a Boolean variable accessed 1330, which indicates whether or not any weight considerations or elementary computations have been popped from the c_stack. The local cost instance is associated with a number of member functions 1332 which include: (1) get_c, which returns the cost generated from the next consideration or elementary computation popped from the c stack; (2) getEdge, which returns the pair of node identifiers that specify the edge associated with the local cost instance; (3) getSum, which returns the sum of costs so far computed by the local cost instance; (4) accessed; which returns a Boolean indication of whether or not a consideration or elementary computation has been popped from the c_stack; and (5) empty, which returns a Boolean indication of whether or not the c_stack is empty. A Cstack instance 1334 is essentially a stack of local cost instances 1336-1339. A Cstack instance is associated with a number of member functions 1340, including: (1) push, which pushes the local cost instances of a received Cstack onto the Cstack instance; (2) get_c, which calls the get_c member function for the most recently pushed local cost instance on the Cstack and returns the cost computed by the local cost instance; (3) pop, which pops the most recently pushed local cost instance from the Cstack; (4) remove; which removes the least-recently pushed local cost instance from the Cstack; and (5) push, which pushes a local cost instance onto the Cstack.

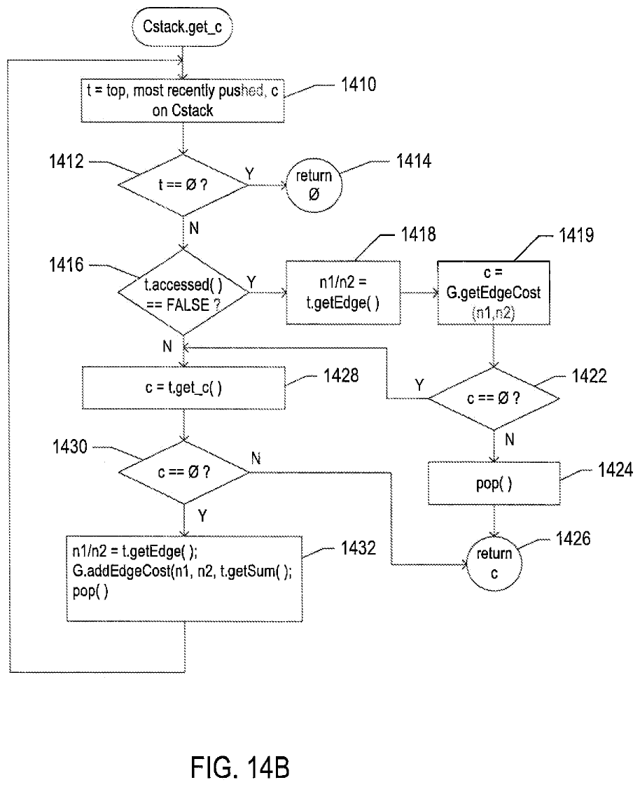

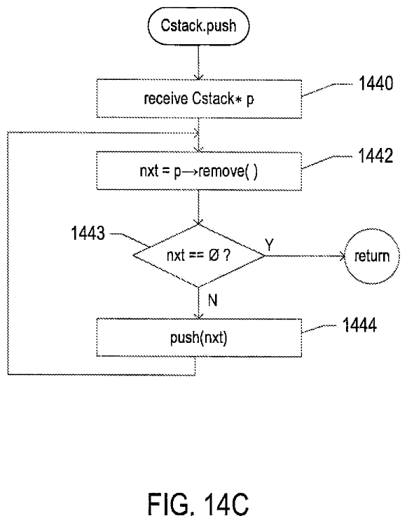

FIGS. 14A-C provide control-flow diagrams for a number of above-mentioned local-cost-instance and Cstack member functions. FIG. 14A provides a control-flow diagram for the local-cost-instance member function get_c. In step 1402, the member function pops a next consideration or elementary computation from the c_stack and uses it to compute a next incremental cost c that contributes to the total weight of the edge associated with the local cost instance. When no consideration or elementary computation is successfully popped from the c_stack, as determined in step 1404, the value Ø is returned, in step 1406. Otherwise, in step 1408, the computed incremental cost c is added to the data member sum and the data member accessed is set to TRUE.

FIG. 14B provides a control-flow diagram for the Cstack member function get_c. In step 1410, the member function sets local variable t to the local cost instance most recently pushed onto the Cstack. When the Cstack is empty, as determined in step 1412, the value Ø is returned, in step 1414. Otherwise, the member function determines, in step 1416, whether or not the local cost instance t has been previously accessed. If so, then, in steps 1418-1419, the member function attempts to retrieve a previously computed final cost for the edge represented by the local cost instance t using the graph member function getEdgeCost. If a final cost has already been computed and stored for the edge, as determined in step 1422, the local cost instance t is popped from the Cstack, in step 1424, and the stored cost for the edge is returned, in step 1426. However, when no final cost has been previously computed for the edge, as determined in step 1422, a next incremental cost c is obtained from the local cost instance t, in step 1428. When the local cost instance returns the value O, as determined in step 1430, the value stored in the data member sum within the local cost instance is added to the stored edge costs within graph G and the local cost instance is popped from the Cstack, in step 1432, with control flowing back to step 1410. When the local cost instance returns a next incremental cost c, as determined in step 1430, that cost is returned in step 1426. Thus, once the total cost of an edge has been computed, it is stored by the graph G and when a local cost instance corresponding to that edge is again encountered, the stored final cost is retrieved from the graph G rather than recomputing the final cost incrementally by the local cost instance.

FIG. 14C provides a control-flow diagram for the first push data member of the Cstack. In step 1440, the member function receives a reference to a different Cstack. Then, in the loop of steps 1442-1444, the member function removes local cost instances from the referenced Cstack and pushes them onto the Cstack.

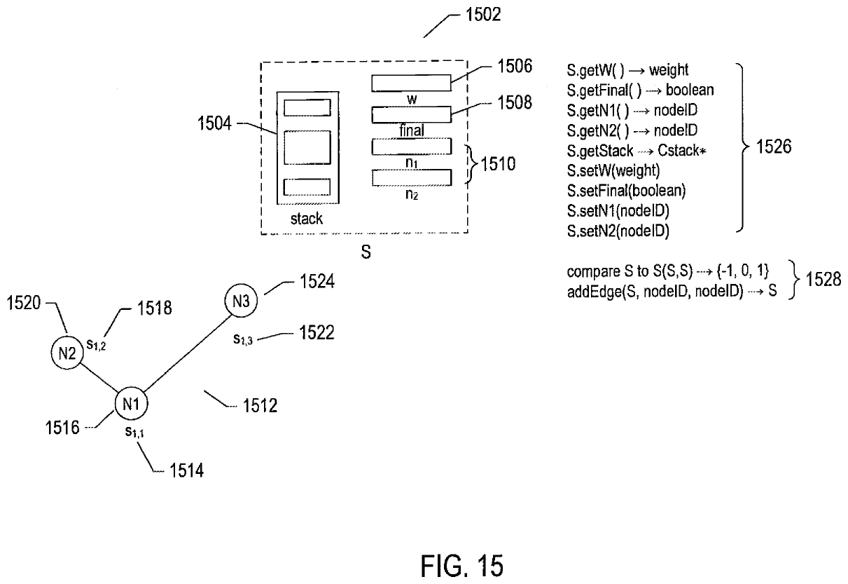

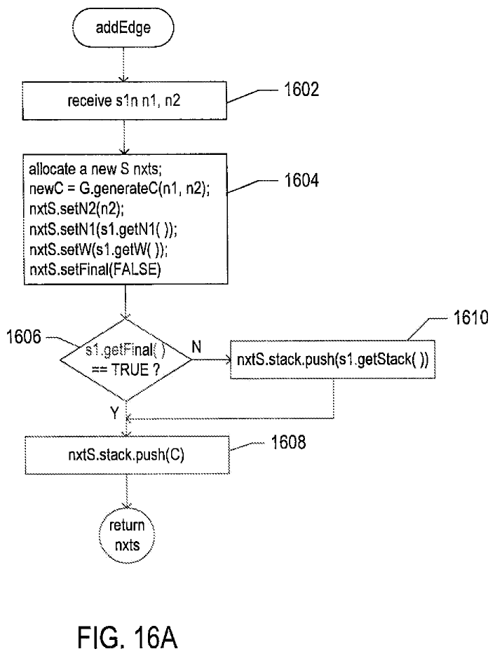

FIG. 15 illustrates a final logical component used in the currently disclosed methods and systems. The final logical component S is an incomplete or complete cumulative path weight, and instances of S are used in place of the distances stored in the dist array in the above-discussed routine “SP.” The logical component S thus provides a mechanism for deferring complete edge-weight computations during the determination of an optimal, local optimal, or near-optimal path within a graph. An S instance 1502 includes a Cstack data member stack 1504, a data member w 1506 that stores the current cumulative weight computed for an edge, a data member final 1508 that stores a Boolean indication of whether or not w stores a final computed edge weight, and a pair of node identifiers 1510 that indicate the final edge of a path for which the incomplete or complete cumulative path weight is represented by the S instance. Thus, in the small example graph 1512 shown in FIG. 15, the S instance s_{1,1} 1514 associated with the source node 1516 represents cumulative path weight 0, the S instance s_{1,2} 1518 associated with node 1520 represents the cumulative path weight from the source node to node 1520, and the S instance s_{1,3} 1522 associated with node 1524 represents the cumulative path weight from the source node to node 1524. The S component is associated with a number of member functions 1526 and two independent functions 1528 including: (1) getW, which returns the value stored in data member w; (2) getFinal, which returns the value stored in data member final; (3) getN1, which returns the value stored in data member n1; (4) getN2, which returns the value stored in data member n2; (5) getStack, which returns a reference to the data member stack; (6) setW, which receives an edge weight and stores the edge weight in data member w; (7) setFinal, which receives a Boolean value and stores the Boolean value in data member final; (8) setN1, which receives a node identifier and stores the node identifier in data member N1; (9) setN2, which receives a node identifier and stores the node identifier in data member N2; (10) compareStoS, which compares two S instances and returns a comparison value indicating whether the distance represented by the first S instance is less than, equal to, or greater than the distance represented by the second S instance; and (11) addEdge, which adds an edge to an initial path associated with an incomplete or complete path distance S to generate a new S instance for a longer path that includes the edge.

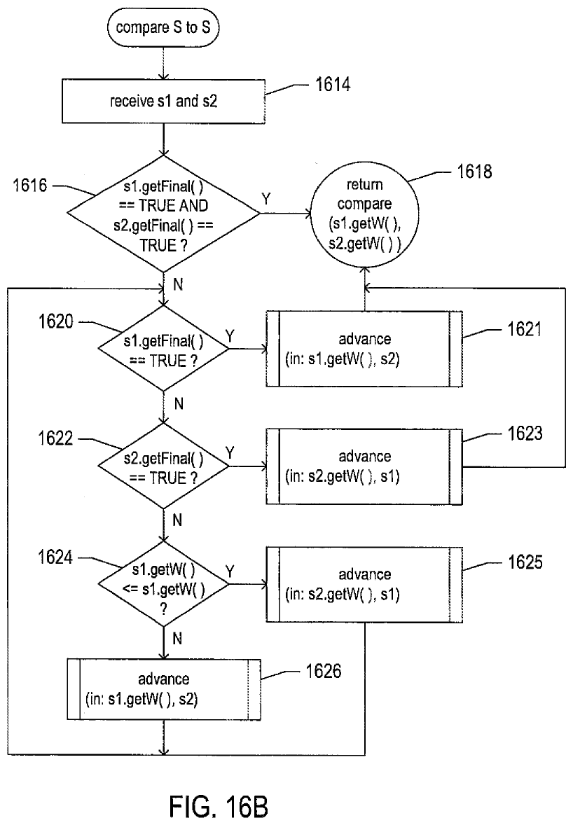

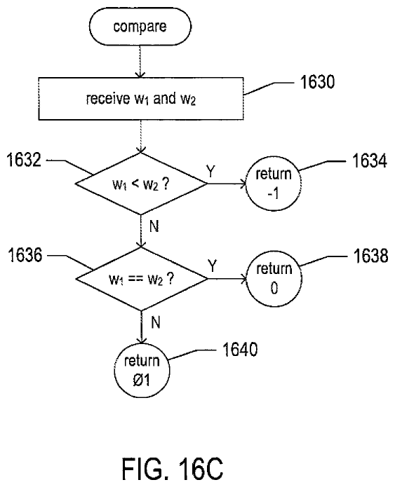

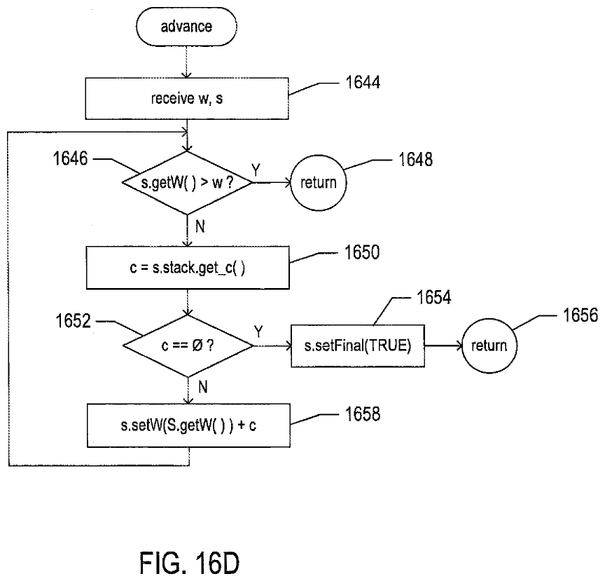

FIGS. 16A-D provide control-flow diagrams for the functions addEdge and compareStoS. FIG. 16A provides a control-flow diagram for the functions addEdge. In step 1602, the function addEdge receives an S instance s1 and two node identifiers n1 and n2 that specify a new edge. In step 1604, the member function addEdge allocates a new S instance nxtS and sets the values of the data members in the new S instance nxtS. A local cost instance newC for nxtS is obtained using the graph member function generateC. Data member N2 of nxtS is set to the terminus of the new edge and data member N1 of nxtS is set to the value stored in data member N1 of S instance s1. The cumulative-path-weight data member w of nxtS is set to the cumulative path weight stored in S instance s1. Finally, the data member final of nxtS is set to FALSE. When S instance s1 stores a final edge weight, as determined in step 1606, the new local cost instance newC is pushed onto the stack of nxtS, in step 1608. Otherwise, the stack in S instance s1 is first pushed onto the stack of nxtS, in step 1610.

FIG. 16B provides a control-flow diagram for the function compareStoS. In step 1614, the function compareStoS receives two S instances s1 and s2. When both of the received S instances store final path weights, as determined in step 1616, the final weights are compared and the comparison result is returned in step 1618. Otherwise, control flows to a loop consisting of steps 1620-1626. When S instance s1 stores a final path weight, as determined in step 1620, a routine “advance” is called, in step 1621, to attempt to advance computation of the incomplete path weight represented by S instance s2, after which the two path weights are compared and the comparison result is returned, in step 1618. Otherwise, when S instance s2 stores a final path weight, as determined in step 1622, the routine “advance” is called, in step 1623, to attempt to advance computation of the incomplete path weight represented by S instance s1, after which the two path weights are compared and the comparison value is returned in step 1618. Otherwise, when the current cumulative path weight represented by S instance s1 is less than the current cumulative path weight represented by S instance s2, the routine “advance” is called, in step 1625, to attempt to advance computation of the incomplete path weight represented by S instance s1, after which control flows back to the first step of the loop of steps 1620-1626. In essence, the incremental path-weight computation is alternatively advanced, in the loop of steps 1620-1626, until one or both of the received S instances represents a final path-weight computation. In more advanced implementations, the comparison may be made based on detected trends and rates of path-weight changes over multiple incremental computations so that incremental computations may be terminated prior to computation of final path weights while still providing statistical, estimated S instance comparisons.

FIG. 16C provides a control-flow diagram for the routine “compare,” called in step 1618 of FIG. 16B. In step 1630, the routine “compare” receives two edge or path weights w1 and w2. In step 1632, the routine “compare” determines whether or not the first weight is less than the second weight. If so, then the routine “compare” returns the value −1, in step 1634. Otherwise, when the first and second weights have equal values, as determined in step 1636, the routine “compare” returns the value 0, in step 1638. Otherwise, when the first weight has a value greater than that of the second weight, the routine “compare” returns the value 1, in step 1640.

FIG. 16D provides a control-flow diagram for the routine “advance.” called in steps 1621, 1623, and 1625-1626 of FIG. 16B. In step 1644, the routine “advance” receives a weight w and an S instance s. When the current cumulative weight stored in the S instances is greater than the received weight, as determined in step 1646, the routine “advance” returns, in step 1648. Otherwise, in step 1650, the routine “advance” calls the get c member function of the stack component within the S instance s in order to carry out an additional incremental weight computation. When the get c member function returns the value Ø, as determined in step 1652, the final data member in the S instance s is set to TRUE, in step 1654, and the routine “advance” returns, in step 1656. Otherwise, in step 1658, the incremental cost is added to the cumulative weight in the S instance s and control flows back to step 1646. In alternative implementations, the routine “advance” may call the member function get c multiple times, in step 1650, in order to advance the cumulative weight represented by S instance s more quickly.

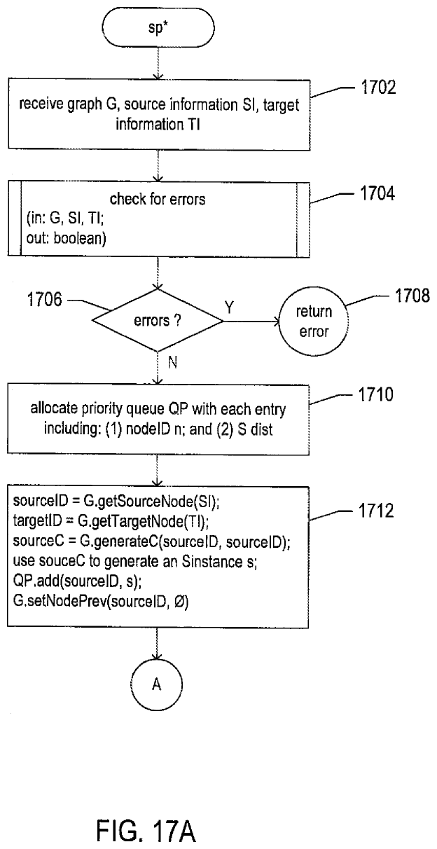

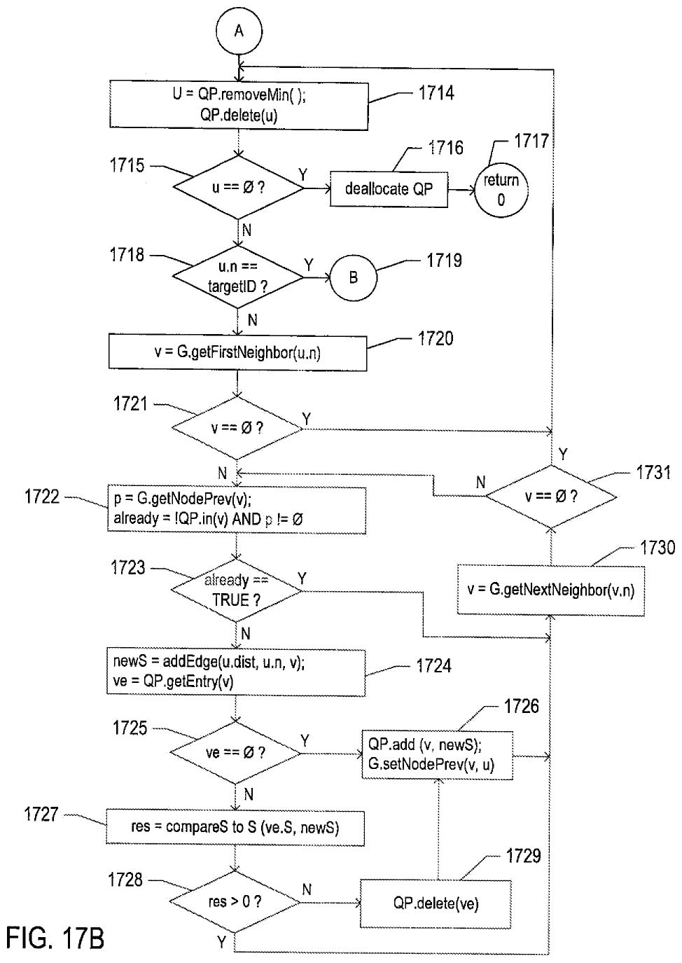

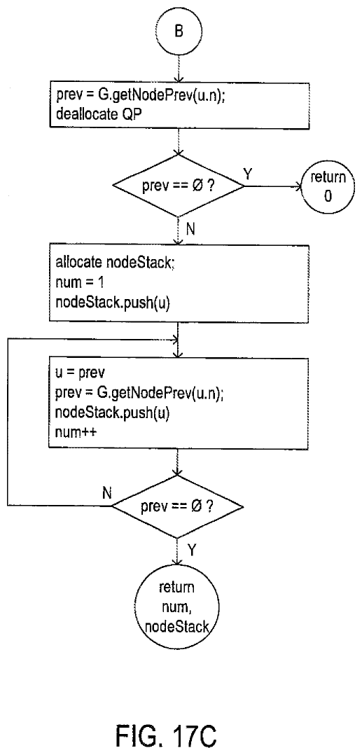

FIGS. 17A-C provide control-flow diagrams for a routine “SP*” that represents one implementation of the currently disclosed methods and systems. The routine “SP*” is similar to the previously discussed routine “SP,” but includes use of the cumulative-weight-representing S instances, rather than absolute weights or distances, and does not initially enumerate all of the nodes in the graph G, but instead begins with only the source and target nodes and expands the graph during the process of determining an optimal, local optimal, or near-optimal path. In step 1702, the routine “SP*” receives a graph G and information about the source and target nodes. In step 1704, the routine “SP*” calls an error-detection routine to detect any errors in the received argument values, similarly to step 804 in FIG. 8A. When errors are detected, as determined in step 1706, an error indication is returned in step 1708. In step 1710, the routine “SP*” allocates a priority queue QP that includes nodes that each include a node identifier n and an S instance dist representing a cumulative path weight, similar to the nodes in the priority queue illustrated in FIG. 10A. In step 1712, the routine “SP*” calls G.getSourceNode and G.getTargetNode to generate the source and target nodes, calls G.generateC to generate a new local cost instance for the source node, uses the new local cost instance to generate an S instance for the source node, adds the source node to the priority queue, and sets the prey node identifier for the source node to the value Ø. Thus, unlike the previously discussed routine “SP,” the routine “SP*” initializes the graph to contain only the source and target nodes.

Turning to FIG. 17B, FIG. 17B shows a loop of steps 1714-1731 similar to the loop of steps 820-833 in FIG. 8B. In step 1714, local variable u is set to the node identifier for the node associated with the smallest cumulative distance retrieved from the priority queue, and the node u is deleted from the priority queue. When local variable u contains the value Ø, as determined in step 1715, the priority queue is deallocated, in step 1716, and the routine “SP*” returns the value 0 in step 1717. Otherwise, when local variable u contains the node identifier for the target node, as determined in step 1718, control flows to the first step in FIG. 17C, discussed below. In step i 720, the routine “SP*” sets local variable v to the first neighbor of node u. When local variable v contains the value O, as determined in step 1721, control flows back to step 1714 for another iteration of the loop of steps 1714-1731. Otherwise, in step 1722, the routine “SP*” sets local variable p to the previous node identifier for node r and sets the local Boolean variable already to indicate whether or not node y is not currently in the priority queue and p is not equal to Ø, which indicates whether or not node v has already been visited. When local variable already contains the value TRUE, as determined in step 1723, control flows to step 1730, discussed below. Otherwise, in step 1724, the routine “SP*” creates a new S instance via the routine “addEdge” and sets local variable ve to reference the priority-queue entry for node v. When local variable ve contains the value Ø, as determined in step 1725, node v is added to the priority queue and the prev node identifier for node v is set to u, in step 1726, and control flows to step 1730, discussed below. Otherwise, in step 1727, the routine compareStoS is called to compare the cumulative distances associated with node v and the new S instance newS. When the cumulative distance represented by S instance newS is less than the cumulative distance currently associated with node v, entry ve is deleted from the priority queue, in step 1729, and a new entry for node r is added to the priority queue in step 1726. In step 1730, the routine “SP*” sets local variable y to a next neighbor of node u. When local variable v contains the value Ø, as determined in step 1731, control flows back to step 1714 for another iteration of the loop of steps 1714-1731. Otherwise, control flows back to step 1722 for another iteration of the inner for-loop of steps 1720-1731.

FIG. 17C shows the generation of the optimal, local optimal, or near-optimal path ending in the target node. The control-flow diagram in FIG. 17C is sufficiently similar to the control-flow diagram in FIG. 8C to not require further annotation. As with the previously discussed routine “SP,” the above-discussed routine “SP*” generates a sequence of graph nodes as an optimal traversal path. This sequence of nodes, and the set of edges connecting them to form the optimal path, represent a solution to a problem represented by the graph. It is assumed that the connecting edges and associated weights are available to the calling entity to reconstruct the traversal path and transform the traversal path into a sequence of objects, actions, and/or or steps that can be executed to solve the problem. Thus, an optimal-graph-traversal method or system is a component of a higher-level method or system that solves an optimization problem by representing the possible problem solutions as a graph and using the optimal-graph-traversal method or system to choose an optimal problem solution for execution. The routine “SP*” represents an improvement to currently available optimal-graph-traversal methods or systems that allows the improved optimal-graph-traversal methods or systems to more efficiently address many types of problems and to address many types of problems that cannot be addressed by currently available optimal-graph-traversal methods or systems, and employment of the improved optimal-graph-traversal methods or systems by a wide variety of higher-level specific-problem-domain-related methods and systems results in improved higher-level specific-problem-domain-related methods and systems more efficiently address many types of real-world problems and to address many types of real-world problems that cannot be addressed by currently available higher-level specific-problem-domain-related methods and systems.

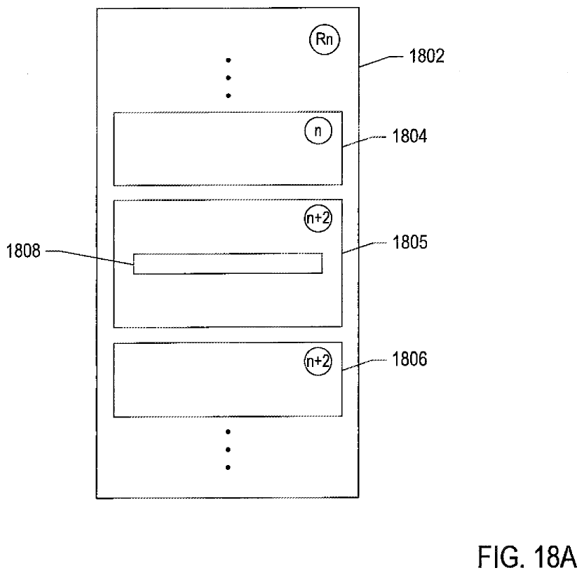

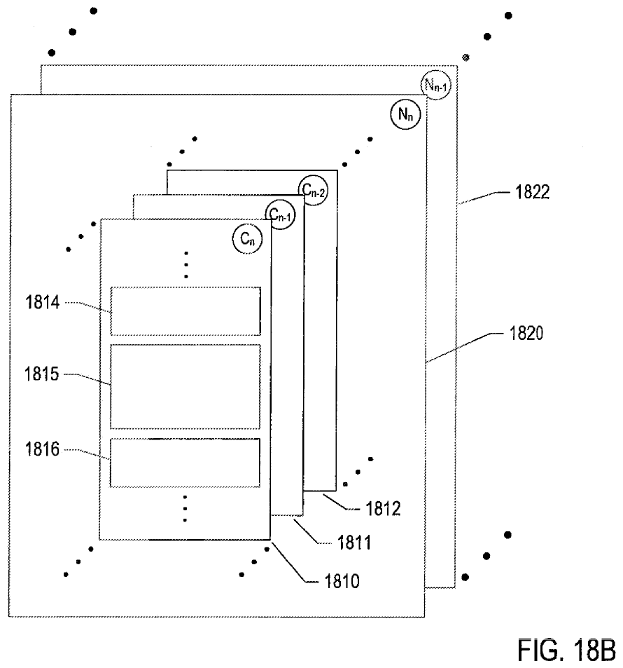

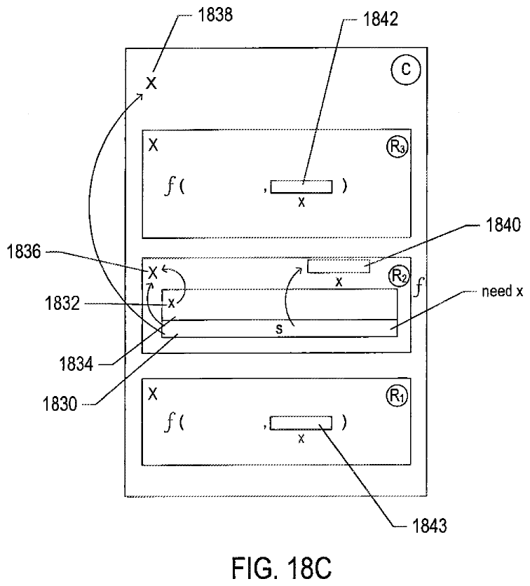

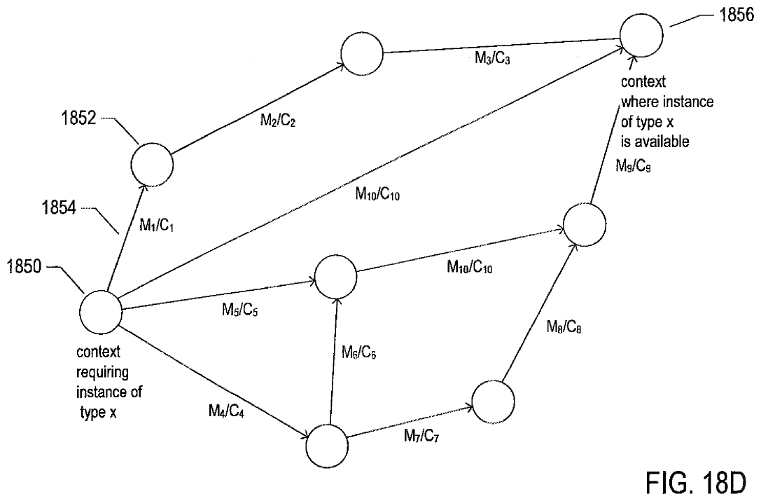

The currently disclosed methods and systems may be incorporated into a variety of different computational processes and systems in order to facilitate various types of optimizations for various different problem domains. One such problem domain involves providing indications, to users of integrated development environments, of optimal or near-optimal code changes that will allow a programmer to access an instance of a particular type from a current programming scope within which the type is not available. FIGS. 18A-D illustrate the general concept of scope and the problem of identifying an optimal, near optimal, or locally optimal sequence of code changes needed to provide access to an instance of a type within a current program scope in which the type is not available. FIG. 18A shows a first level of scopes. The outer rectangle 1802 represents a routine, rectangles 1804-1806 represent scopes within the routine, and innermost rectangle 1808 represents one or more program statements within the scope 1805. For example, scope 1805 may be a scope associated with a control structure, such as a for loop. FIG. 18B shows a second level of scopes. Rectangles 1810-1812 represent classes that each contain member functions, such as member functions 1814-1816 within class 1810. Classes 1810-1812 are contained within a first namespace 1820. A program may contain multiple namespaces, including additional namespace 1822.

FIG. 18C illustrates a simple example of various different code changes to provide access to an instance of type X within a particular scope S. A programmer adding code to scope S 1830 may need access to an instance of type X. However, no such instance is currently available in scope S. It may be the case that an instance of type X 1832 is available in a preceding scope 1834. This instance of type X may be made available by declaring the instance of type X at a higher-level scope 1836 from which it is available both to scopes 1832 and 1830. As another alternative, the instance of type X could be instead declared as a member of the containing class 1838 so that it is available to scopes 1830 and 1832. As yet another possibility, an instance of type X could be passed as a parameter 1842 to the routine containing scope S, allowing that parameter to be accessed from scope S. This would involve adding the new parameter in all calls to the routine 1842-1843. In a large program, there may be myriad different approaches to providing access to an instance of a particular type within a scope in which the type is not available, and may involve many different code changes. Each code change is associated with a cost. The costs may reflect the number of secondary and tertiary code changes required for the code change, the desirability or undesirability of using certain types of code changes, computational efficiency overheads associated with particular code changes, and many other factors. The problem of determining an optimal set of code changes in order to render a particular type accessible to a particular program scope can be expressed as an optimal-path determination for a code-change graph, such as that shown in FIG. 18D, in which each node represents a program state and the edges connecting nodes are each associated with a code change, or modification. M and an associated cost C. The code change changes the program state from an initial program state to a subsequent state represented by the two nodes connected by a directed edge, such as the source state represented by node 1850 and the state represented by node 1852 connected by edge 1854 associated with code change M₁ and cost C₁, with code change M₁ changing the program state from the state represented by node 1850 to the state represented by node 1852. The source node 1850 represents the current state of a program in which a needed instance is not accessible within a particular scope within the program and the target node 1856 represents the state of the program following a sequence of one or more code changes in which the needed instance is accessible from the particular scope within the program. Application of the above-discussed routine “SP*,” in which the graph represents program-state transitions, can then determine an optimal, local optimal, or near-optimal sequence of code changes to provide access to an instance of a particular type from a particular program scope.

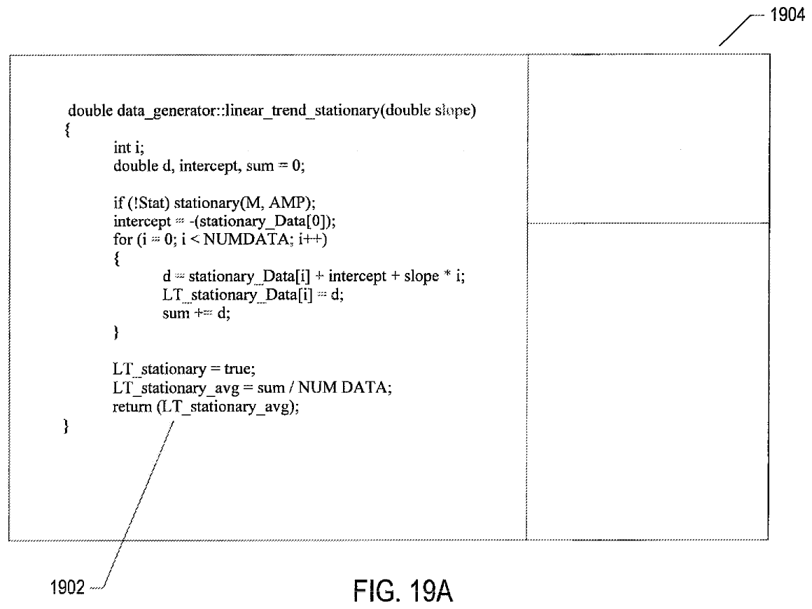

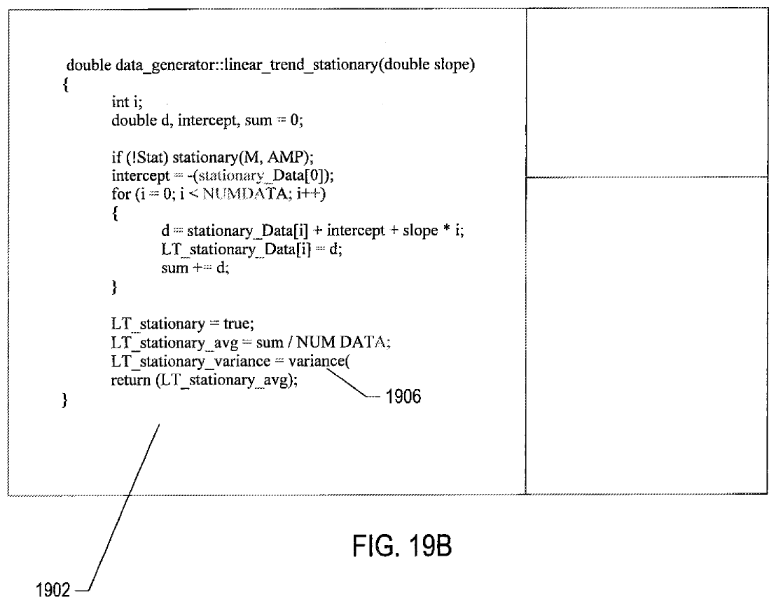

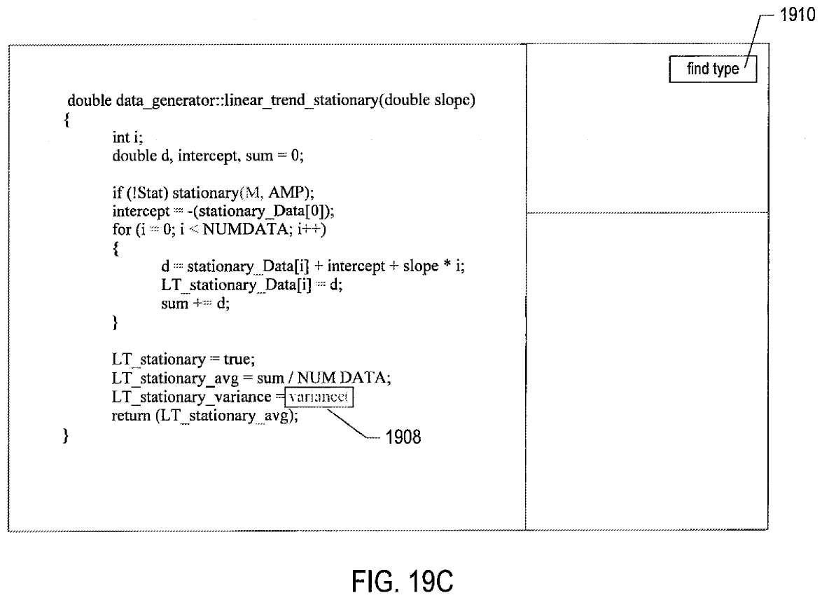

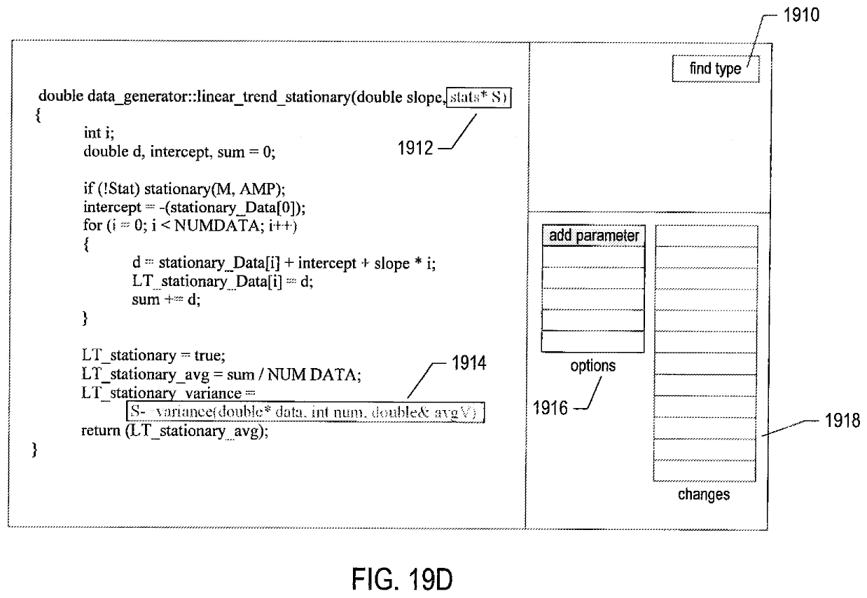

FIGS. 19A-D illustrates an integrated development environment (“IDE”) interface in which the currently disclosed optimization methods and systems can be employed to determine optimal, near optimal, or locally optimal sequences of code changes. FIG. 19A shows an initial review of a routine 1902 within the IDE screen 1904. As shown in FIG. 19B, a programmer has begun to add a new statement 1906 to routine 1902, but realizes that there is no variance method currently available from the scope of this routine. As shown in FIG. 19C, the programmer has highlighted or otherwise indicated the needed type 1908 and invoked a code-change-sequence feature 1910 to indicate a sequence of code changes that would provide access to a variance routine. As shown in FIG. 19D, the IDE has computed an optimal set of code changes, a portion of which are highlighted 1912 in 1914 in the displayed IDE interface. The IDE may provide additional sets of code changes for consideration 1916 and may also provide navigation tools for the programmer to step through all of the secondary, tertiary, and additional code changes that need to be carried out within the program to affect the currently selected code-change option 1918.

The present invention has been described in terms of particular embodiments, it is not intended that the invention be limited to these embodiments. Modifications within the spirit of the invention will be apparent to those skilled in the art. For example, any of many different implementations of the currently disclosed methods and systems can be obtained by varying various design and implementation parameters, including modular organization, control structures, data structures, hardware, operating system, and virtualization layers, automated orchestration systems, virtualization-aggregation systems, and other such design and implementation parameters.

1. A graph-traversal-identification subsystem within a problem-addressing system, the graph-traversal-identification subsystem comprising:
one or more processors;
one or more memories; and
computer instructions, stored in one or more of the one or more memories that, when executed by one or more of the one or more processors, control the graph-traversal-identification system to
receive information about a problem, a source, and a target from the problem-addressing system,
initialize a graph that represents possible solutions to the problem to include a source node and a target node corresponding to the received information about the source and the target,
associate the source node with a source-node cumulative path weight,
expand the graph outward from the source node by
iteratively
selecting an already generated node of the graph, and
tracking an optimal, near-optimal, or locally-optimal path from the source node to the nodes which neighbor the selected node, each neighbor node associated with a deferrable cumulative weight representing the cumulative weight of a path from the source node to the neighbor node
until the selected node is the target node,
encoding an optimal, near optimal, or locally optimal traversal path that includes the source node and the target node and that may include one or more additional nodes, and
providing the encoded traversal path to the problem-addressing system, which uses the encoded traversal path to address the problem.

2. The graph-traversal-identification subsystem of claim 1 wherein the graph comprises:
multiple nodes; and
multiple edges that each connects two nodes and that each is associated with a weight.

3. The graph-traversal-identification subsystem of claim 2
wherein an optimal, near optimal, or locally optimal traversal path begins with the source node, ends with the target node;
wherein the optimal, near optimal, or locally optimal traversal path may include one or more additional nodes;
wherein, when optimal, near optimal, or locally optimal traversal path includes only the source node and the target node, the optimal traversal path includes an edge that connects the source node to the target node;
wherein, when optimal, near optimal, or locally optimal traversal path includes one or more additional nodes, the optimal traversal path includes edges that interconnect the source node through the one or more additional nodes to the target node; and
wherein the cumulative weight of the optimal traversal path, which is the sum of the weights of the edges in the optimal traversal path, meets an optimization condition.

4. The graph-traversal-identification subsystem of claim 3
wherein the optimization condition requires that the cumulative weight of an optimal traversal path is less than or equal to the cumulative weights of all other traversal paths in the graph when the graph represents a minimization problem;
wherein the optimization condition requires that the difference between the cumulative weight of a near-optimal path and the cumulative weight of an optimal path of the graph is less than or equal to a threshold fraction of the cumulative weight of the optimal path when the graph represents a minimization problem;
wherein the optimization condition requires that the cumulative weight of a locally optimal traversal path is less than or equal to the cumulative weights of all other traversal paths discovered in the graph when the graph represents a minimization problem;
wherein the optimization condition requires that the cumulative weight of an optimal traversal path is greater than or equal to the cumulative weights of all other traversal paths in the graph when the graph represents a maximization problem;
wherein the optimization condition requires that the difference between the cumulative weight of an optimal path of the graph and the cumulative weight of a near-optimal path is less than or equal to a threshold fraction of the cumulative weight of the optimal path when the graph represents a maximization problem; and
wherein the optimization condition requires that the cumulative weight of a locally optimal traversal path is greater than or equal to the cumulative weights of all other traversal paths discovered in the graph when the graph represents a maximization problem.

5. The graph-traversal-identification subsystem of claim 1
wherein a deferrable cumulative weight is iteratively or recursively computed as the sum of incremental weights;
wherein a deferrable cumulative weight has a provisional weight at a particular point in time equal to the sum of incremental weights iteratively or recursively computed up to the point in time; and
wherein a deferrable cumulative weight has a final weight when there are no further incremental weights that can be iteratively or recursively computed and added to the final weight.

6. The graph-traversal-identification subsystem of claim 5 wherein a first deferrable cumulative weight is compared to a second deferrable cumulative weight by
iteratively
when the first deferrable cumulative weight has a final weight and the second deferrable cumulative weight has a final weight,
comparing the first deferrable cumulative weight to the second deferrable cumulative weight to generate a comparison result, and
returning the comparison result;
when the first deferrable cumulative weight has a final weight and the second deferrable cumulative weight has a provisional weight,
when the provisional weight of the second deferrable cumulative weight is greater than the final weight of the first deferrable cumulative weight, returning an indication that the first deferrable cumulative weight is less than the second deferrable cumulative weight, and
otherwise, attempting to advance the provisional weight of the second deferrable cumulative weight past the first deferrable cumulative weight;
when the second deferrable cumulative weight has a final weight and the first deferrable cumulative weight has a provisional weight,
when the provisional weight of the first deferrable cumulative weight is greater than the final weight of the second deferrable cumulative weight, returning an indication that the second deferrable cumulative weight is less than the first deferrable cumulative weight, and
otherwise, attempting to advance the provisional weight of the first deferrable cumulative weight past the second deferrable cumulative weight; and
when the first deferrable cumulative weight has a provisional weight and the second deferrable cumulative weight has a provisional weight,
when the provisional weight of the first deferrable cumulative weight is less than or equal to the provisional weight of the second deferrable cumulative weight, attempting to advance the provisional weight of the first deferrable cumulative weight past the second deferrable cumulative weight, and
otherwise attempting to advance the provisional weight of the second deferrable cumulative weight past the first deferrable cumulative weight.

7. The graph-traversal-identification subsystem of claim 6 wherein, when both a first deferrable cumulative weight and a second deferrable cumulative weight have final weights, the first deferrable cumulative weight is compared to a second deferrable cumulative weight by:
when the final weight of the first deferrable cumulative weight is less than the final weight of the second deferrable cumulative weight, and returning an indication that the first deferrable cumulative weight is less than the final weight of the second deferrable cumulative weight;
when the final weight of the first deferrable cumulative weight is equal to the final weight of the second deferrable cumulative weight, returning an indication that the first deferrable cumulative weight is equal to the second deferrable cumulative weight; and
when the final weight of the first deferrable cumulative weight is greater than the final weight of the second deferrable cumulative weight, returning an indication that the first deferrable cumulative weight is greater than the second deferrable cumulative weight.

8. The graph-traversal-identification subsystem of claim 6 wherein a first deferrable cumulative weight having a provisional weight is attempted to be advanced past a second deferrable cumulative weight by advancing the first deferrable cumulative weight until either the first deferrable cumulative weight has a final weight or until the provisional weight of the first cumulative weight is greater than the provisional weight or final weight of the second deferrable cumulative weight.

9. The graph-traversal-identification subsystem of claim 8 wherein a deferrable cumulative weight having a provisional weight is advanced by carrying out an iterative or recursive computation to generate an incremental weight that is added to the sum of incremental weights iteratively or recursively computed for the deferrable cumulative weight.

10. The graph-traversal-identification subsystem of claim 6 further comprising a set of unvisited-node indications that is initialized to include an indication of the source node.

11. The graph-traversal-identification subsystem of claim 10 wherein selecting an already generated node of the graph while expanding the graph outward from the source node further comprises:
when the optimal, near optimal, or locally optimal traversal path has a lower cumulative weight than other possible paths from the source node to the target node,
selecting, from the set of unvisited-node indications, a node associated with a deferrable cumulative weight less than or equal to any deferrable cumulative weight associated with an unselected node in the set of unvisited-node indications; and
when the optimal, near optimal, or locally optimal traversal path has a greater cumulative weight than other possible paths from the source node to the target node,
selecting, from the set of unvisited-node indications, a node associated with a deferrable cumulative weight greater than or equal to any deferrable cumulative weight associated with an unselected node in the set of unvisited-node indications.

12. The graph-traversal-identification subsystem of claim 10 wherein expanding the graph outward from the source node further comprises, following selecting an already generated node of the graph:
generating new deferrable cumulative weights for nodes that neighbor the selected node which have already been generated and added to the graph;
generating new nodes that neighbor the selected node which have not yet been generated;
generating new deferrable cumulative weights for the new nodes;
associating the new deferrable cumulative weights with the new neighbor nodes; and
adding the new neighbor nodes to the graph.

13. The graph-traversal-identification subsystem of claim 12 wherein a new deferrable cumulative weight is generated for a neighbor node of the selected node by:
generating a new deferrable cumulative weight;
including, in the new deferrable cumulative weight, a provisional weight equal to the provisional weight or final weight of the deferrable cumulative weight associated with the selected node;
including, in the new deferrable cumulative weight, any remaining iterative or recursive computations of the selected node not yet used to compute incremental weights for the selected weights; and
adding, to the new deferrable cumulative weight, iterative or recursive computations related to the edge that connects the selected node to the generated neighbor node.

14. The graph-traversal-identification subsystem of claim 10 wherein tracking an optimal, near-optimal, or locally-optimal path from the source node to nodes which neighbor the selected node further comprises:
for each node that neighbors the selected node,
when the node was generated and added to the graph during the current graph-expansion iteration,
adding the node to the set of unvisited nodes, and
associating the node with an indication that the selected node precedes the node; and
when the node was not generated and added to the graph during the current graph-expansion iteration and when comparison of the new deferrable cumulative weight for the node to the deferrable cumulative weight associated with the node indicates that an optimal, near-optimal, or locally optimal path from the source node to the node should include the selected node,
associating the new deferrable cumulative weight for the node with the node, and
associating the node with an indication that the selected node precedes the node.

15. The graph-traversal-identification subsystem of claim 1
wherein the problem is involves providing indications, to users of integrated development environments, of optimal or near-optimal code changes that will allow a programmer to access an instance of a particular type from a current programming scope within which the type is not available;
wherein the source is an initial program state;
wherein the target is a program state, obtained following a sequence of one or more code changes, in which the particular type is accessible from the current programming scope; and
wherein each node of the graph represents a program state and each edge of the graph represents a code change.

16. A method that improves a graph-traversal-identification subsystem, the method comprising:
identifying path weights and edge weights used by graph-traversal-identification subsystem; and
replacing the path weights and edge weights with deferrable cumulative weights.

17. The method of claim 16
wherein a deferrable cumulative weight is iteratively or recursively computed as the sum of incremental weights;
wherein a deferrable cumulative weight has a provisional weight at a particular point in time equal to the sum of incremental weights iteratively or recursively computed up to the point in time; and
wherein a deferrable cumulative weight has a final weight when there are no further incremental weights that can be iteratively or recursively computed and added to the final weight.

18. The method of claim 17 wherein a first deferrable cumulative weight is compared to a second deferrable cumulative weight by
iteratively
when the first deferrable cumulative weight has a final weight and the second deferrable cumulative weight has a final weight,
comparing the first deferrable cumulative weight to the second deferrable cumulative weight to generate a comparison result, and
returning the comparison result;
when the first deferrable cumulative weight has a final weight and the second deferrable cumulative weight has a provisional weight,
when the provisional weight of the second deferrable cumulative weight is greater than the final weight of the first deferrable cumulative weight, returning an indication that the first deferrable cumulative weight is less than the second deferrable cumulative weight, and
otherwise, attempting to advance the provisional weight of the second deferrable cumulative weight past the first deferrable cumulative weight;
when the second deferrable cumulative weight has a final weight and the first deferrable cumulative weight has a provisional weight,
when the provisional weight of the first deferrable cumulative weight is greater than the final weight of the second deferrable cumulative weight, returning an indication that the second deferrable cumulative weight is less than the first deferrable cumulative weight, and
otherwise, attempting to advance the provisional weight of the first deferrable cumulative weight past the second deferrable cumulative weight; and
when the first deferrable cumulative weight has a provisional weight and the second deferrable cumulative weight has a provisional weight,
when the provisional weight of the first deferrable cumulative weight is less than or equal to the provisional weight of the second deferrable cumulative weight, attempting to advance the provisional weight of the first deferrable cumulative weight past the second deferrable cumulative weight, and
otherwise attempting to advance the provisional weight of the second deferrable cumulative weight past the first deferrable cumulative weight.

19. The method of claim 18 wherein, when both a first deferrable cumulative weight and a second deferrable cumulative weight have final weights, the first deferrable cumulative weight is compared to a second deferrable cumulative weight by:
when the final weight of the first deferrable cumulative weight is less than the final weight of the second deferrable cumulative weight, and returning an indication that the first deferrable cumulative weight is less than the final weight of the second deferrable cumulative weight;
when the final weight of the first deferrable cumulative weight is equal to the final weight of the second deferrable cumulative weight, returning an indication that the first deferrable cumulative weight is equal to the second deferrable cumulative weight; and
when the final weight of the first deferrable cumulative weight is greater than the final weight of the second deferrable cumulative weight, returning an indication that the first deferrable cumulative weight is greater than the second deferrable cumulative weight.

20. The method of claim 19
wherein a first deferrable cumulative weight having a provisional weight is attempted to be advanced past a second deferrable cumulative weight by advancing the first deferrable cumulative weight until either the first deferrable cumulative weight has a final weight or until the provisional weight of the first cumulative weight is greater than the provisional weight or final weight of the second deferrable cumulative weight; and
wherein a deferrable cumulative weight having a provisional weight is advanced by carrying out an iterative or recursive computation to generate an incremental weight that is added to the sum of incremental weights iteratively or recursively computed for the deferrable cumulative weight.

21. A physical data-storage device encoded with computer instructions that, when executed by one or more processors of a graph-traversal-identification subsystem, within a problem-addressing system, having one or more processors and one or more memories that store the computer instructions, control the graph-traversal-identification subsystem to
receive information about a problem, a source, and a target from the problem-addressing system,
initialize a graph that represents possible solutions to the problem to include a source node and a target node corresponding to the received information about the source and the target,
associate the source node with a source-node cumulative path weight,
expand the graph outward from the source node by
iteratively
selecting an already generated node of the graph, and
tracking an optimal, near-optimal, or locally-optimal path from the source node to the nodes which neighbor the selected node, each neighbor node associated with a deferrable cumulative weight representing the cumulative weight of a path from the source node to the neighbor node
until the selected node is the target node,
encoding an optimal, near optimal, or locally optimal traversal path that includes the source node and the target node and that may include one or more additional nodes, and
providing the encoded traversal path to the problem-addressing system, which uses the encoded traversal path to address the problem.
